(19) United States
(12) Patent Application Publication
(10) Pub. No.: US 2025/0123738 A1
(43) Pub. Date: Apr. 17, 2025

(54) LIGHTING USER INTERFACES

(71) Applicant: Apple Inc., Cupertino, CA (US)

(72) Inventors: Charles D. DEETS, San Jose, CA (US); Patrick L. COFFMAN, San Francisco, CA (US)

(21) Appl. No.: 18/991,065

(22) Filed: Dec. 20, 2024

Related U.S. Application Data
(63) Continuation of application No. 17/031,877, filed on Sep. 24, 2020.
(60) Provisional application No. 63/039,802, filed on Jun. 16, 2020.

(51) Int. Cl. G06F 3/04847; G06F 3/0481; H05B 47/105; H05B 47/175

(52) U.S. Cl. CPC G06F 3/04847; G06F 3/0481; H05B 47/105; H05B 47/175

(57) ABSTRACT

The present disclosure generally relates to lighting user interfaces. A notification corresponding to an automated lighting feature is displayed on a user interface of a home automation system in accordance with a determination that the user interface is displayed for the first time since associating a lighting accessory with the home automation system. The notification includes an activation user interface object and a cancel user interface object.

### CROSS-REFERENCE TO RELATED APPLICATIONS

This application is a continuation of U.S. patent application Ser. No. 17/031,877, filed Sep. 24, 2020, entitled “LIGHTING USER INTERFACES,” which claims priority to U.S. Provisional Patent Application Ser. No. 63/039,802, filed Jun. 16, 2020, entitled “LIGHTING USER INTERFACES,” the entire contents of each of which are hereby incorporated by reference.

### FIELD

The present disclosure relates generally to computer user interfaces, and more specifically to techniques for managing light accessories.

### BACKGROUND

Users have the ability to control lighting accessories that are included in their home via electronic devices. For example, users can control the lighting accessories to turn on and/or off, control the lighting accessories to change color, and/or set schedules for turning on and/or off the lighting accessories.

### BRIEF SUMMARY

Some techniques for managing light accessories using electronic devices, however, are generally cumbersome and inefficient. For example, some existing techniques use a complex and time-consuming user interface, which may include multiple key presses or keystrokes. For another example, some existing techniques enable users to set schedules to turn on and/or off lighting accessories, but require users to manually change other settings (e.g., color temperature settings and/or brightness settings) to desired levels throughout the day. In addition, some existing techniques do not provide a setting that automatically adjusts settings to resemble natural light throughout the day. Existing techniques require more time than necessary, wasting user time and device energy. This latter consideration is particularly important in battery-operated devices.

Accordingly, the present technique provides electronic devices with faster, more efficient methods and interfaces for managing light accessories. Such methods and interfaces optionally complement or replace other methods for managing light accessories. Such methods and interfaces reduce the cognitive burden on a user and produce a more efficient human-machine interface. For battery-operated computing devices, such methods and interfaces conserve power and increase the time between battery charges. Additionally, such methods and interfaces reduce the number of unnecessary or extraneous inputs required by the user.

A method is described, in accordance with some embodiments. The method includes, at an electronic device with a display: displaying, on the display, a user interface including a plurality of affordances to control a light, the plurality of affordances include: a first affordance configured to, in response to detecting user input corresponding to the first affordance, cause adjustment of a color temperature setting of the light to a variable color temperature that is based on one or more environmental characteristics, the one or more environmental characteristics include a current time of day; and a second affordance, different from the first affordance, configured to, in response to detecting user input corresponding to the second affordance, cause adjustment of the color temperature setting of the light to a particular color temperature; while displaying the user interface, detecting first user input; and in response to detecting the first user input and in accordance with a determination that the first user input corresponds to the first affordance, causing adjustment of the color temperature setting of the light to the variable color temperature that is based on the one or more environmental characteristics.

A non-transitory computer-readable storage medium is described, in accordance with some embodiments. The non-transitory computer readable storage medium stores one or more programs configured to be executed by one or more processors of an electronic device with a display, the one or more programs including instructions for: displaying, on the display, a user interface including a plurality of affordances to control a light, the plurality of affordances include: a first affordance configured to, in response to detecting user input corresponding to the first affordance, cause adjustment of a color temperature setting of the light to a variable color temperature that is based on one or more environmental characteristics, the one or more environmental characteristics include a current time of day; and a second affordance, different from the first affordance, configured to, in response to detecting user input corresponding to the second affordance, cause adjustment of the color temperature setting of the light to a particular color temperature; while displaying the user interface, detecting first user input; and in response to detecting the first user input and in accordance with a determination that the first user input corresponds to the first affordance, causing adjustment of the color temperature setting of the light to the variable color temperature that is based on the one or more environmental characteristics.

A transitory computer-readable storage medium is described, in accordance with some embodiments. The transitory computer-readable storage medium stores one or more programs configured to be executed by one or more processors of an electronic device with a display, the one or more programs including instructions for: displaying, on the display, a user interface including a plurality of affordances to control a light, the plurality of affordances include: a first affordance configured to, in response to detecting user input corresponding to the first affordance, cause adjustment of a color temperature setting of the light to a variable color temperature that is based on one or more environmental characteristics, the one or more environmental characteristics include a current time of day; and a second affordance, different from the first affordance, configured to, in response to detecting user input corresponding to the second affordance, cause adjustment of the color temperature setting of the light to a particular color temperature; while displaying the user interface, detecting first user input; and in response to detecting the first user input and in accordance with a determination that the first user input corresponds to the first affordance, causing adjustment of the color temperature setting of the light to the variable color temperature that is based on the one or more environmental characteristics.

An electronic device is described, in accordance with some embodiments. The electronic device includes a display; one or more processors; and memory storing one or more programs configured to be executed by the one or more processors, the one or more programs including instructions for: displaying, on the display, a user interface including a plurality of affordances to control a light, the plurality of affordances include: a first affordance configured to, in response to detecting user input corresponding to the first affordance, cause adjustment of a color temperature setting of the light to a variable color temperature that is based on one or more environmental characteristics, the one or more environmental characteristics include a current time of day; and a second affordance, different from the first affordance, configured to, in response to detecting user input corresponding to the second affordance, cause adjustment of the color temperature setting of the light to a particular color temperature; while displaying the user interface, detecting first user input; and in response to detecting the first user input and in accordance with a determination that the first user input corresponds to the first affordance, causing adjustment of the color temperature setting of the light to the variable color temperature that is based on the one or more environmental characteristics.

An electronic device is described, in accordance with some embodiments. The electronic device includes a display; means for displaying, on the display, a user interface including a plurality of affordances to control a light, the plurality of affordances include: a first affordance configured to, in response to detecting user input corresponding to the first affordance, cause adjustment of a color temperature setting of the light to a variable color temperature that is based on one or more environmental characteristics, the one or more environmental characteristics include a current time of day; and a second affordance, different from the first affordance, configured to, in response to detecting user input corresponding to the second affordance, cause adjustment of the color temperature setting of the light to a particular color temperature; while displaying the user interface, means for detecting first user input; and in response to detecting the first user input and in accordance with a determination that the first user input corresponds to the first affordance, means for causing adjustment of the color temperature setting of the light to the variable color temperature that is based on the one or more environmental characteristics.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing light accessories, thereby increasing the effectiveness, efficiency, and user satisfaction with such devices. Such methods and interfaces may complement or replace other methods for managing light accessories.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6O illustrate exemplary user interfaces for managing light accessories in accordance with some embodiments.

FIGS. 7A and 7B illustrate exemplary graphical representations of an automated lighting feature in accordance with some embodiments.

FIG. 8 illustrates a flow diagram for managing light accessories in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing light accessories. For example, a user interface that enables a user to select an automated lighting feature that adjusts settings of a lighting accessory throughout the day without further user interaction reduces an amount of inputs required by the user to cause the lighting accessory to emulate natural light. Such techniques can reduce the cognitive burden on a user who manages light accessories, thereby enhancing productivity. Further, such techniques can reduce processor and battery power otherwise wasted on redundant user inputs.

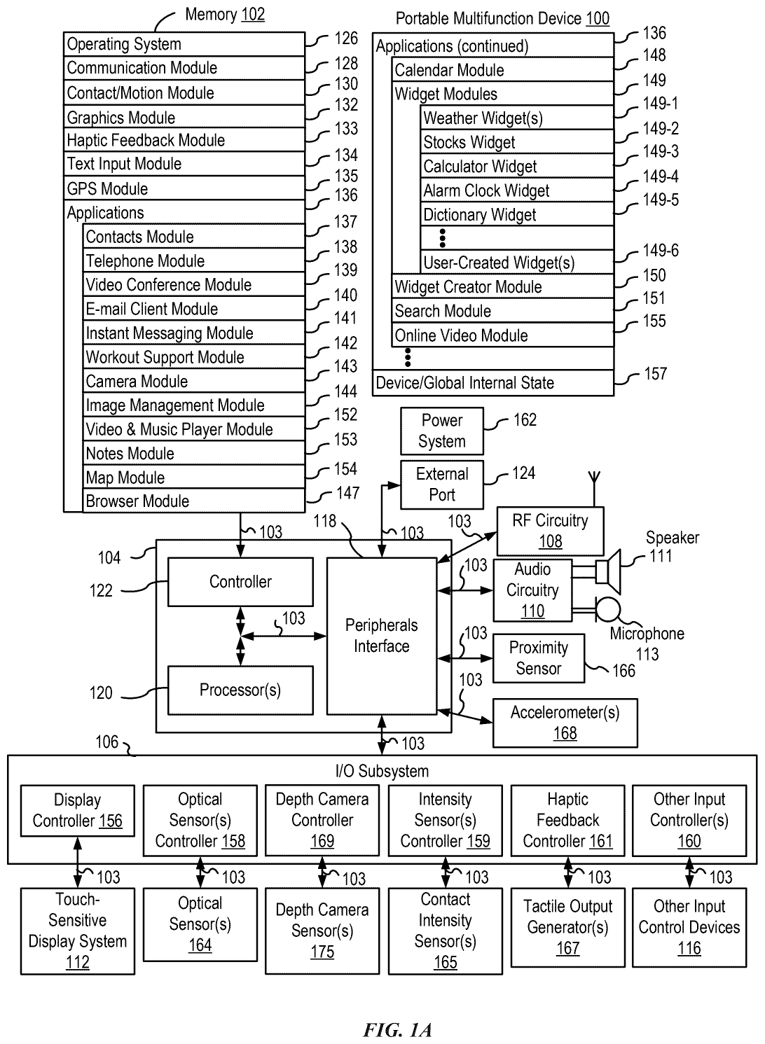

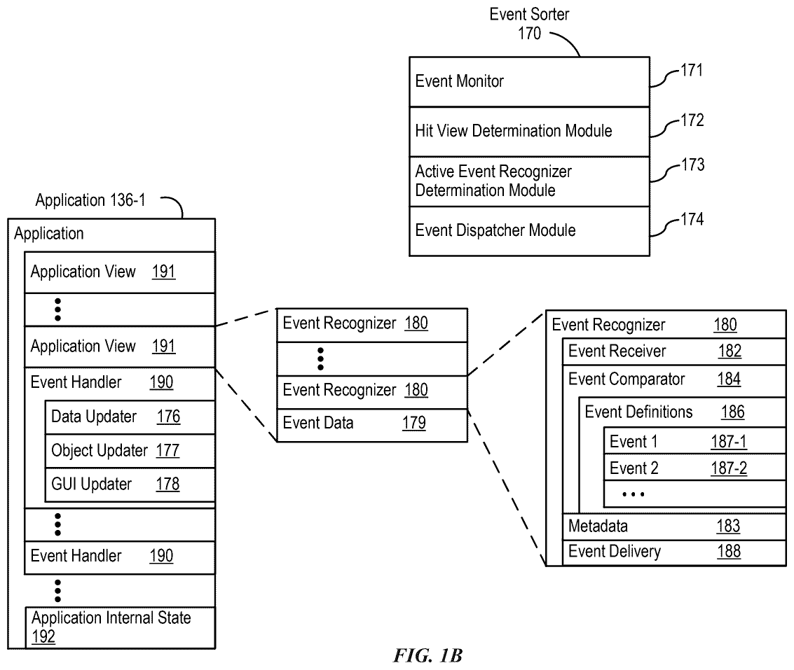

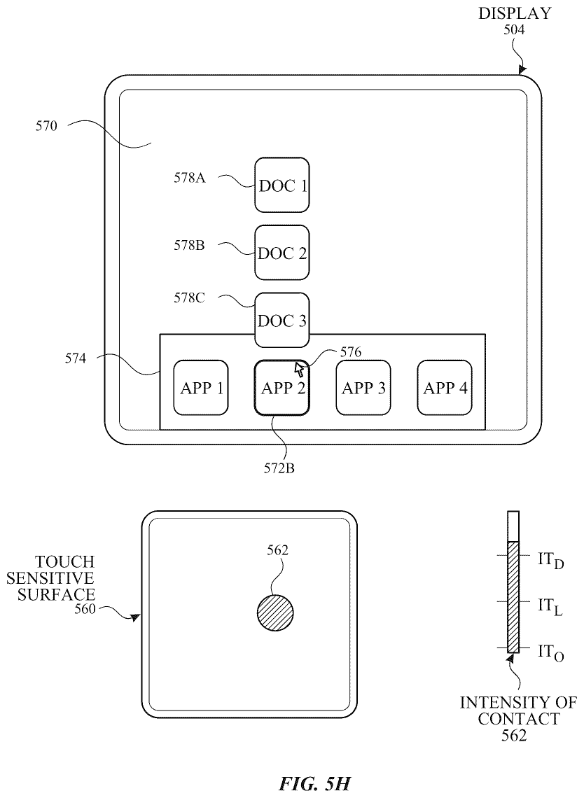

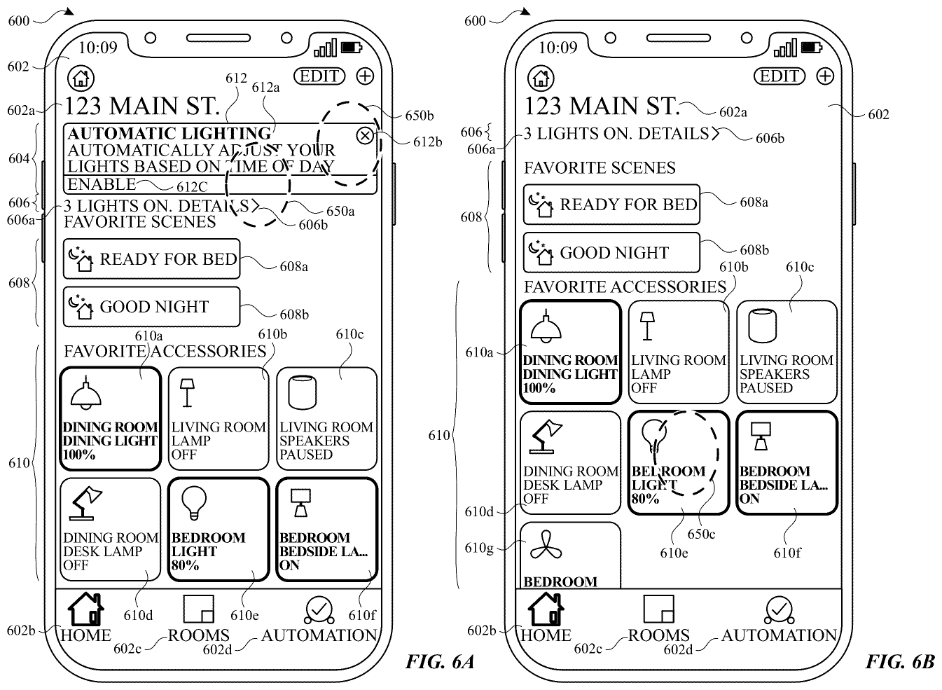

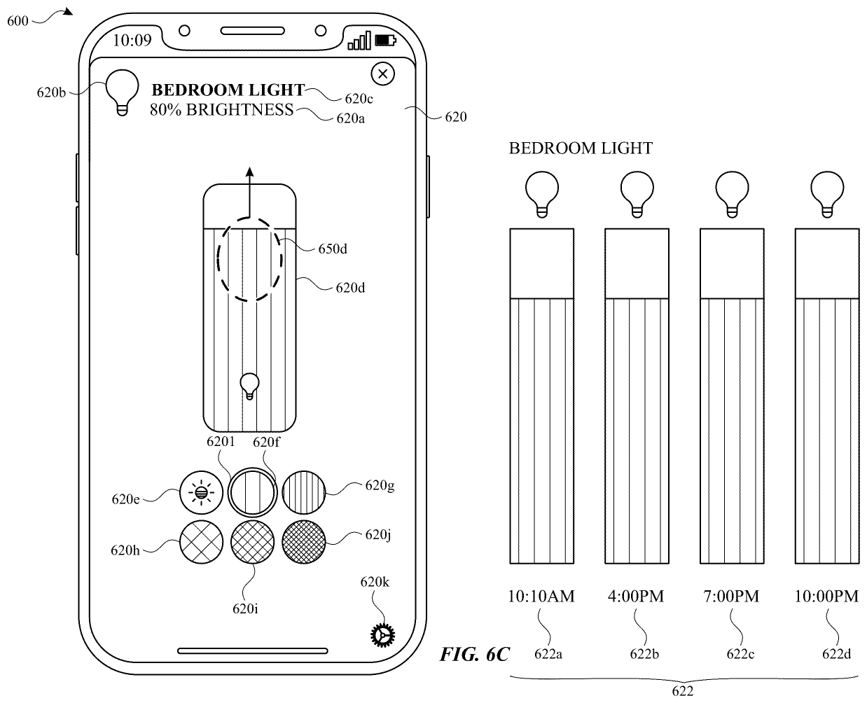

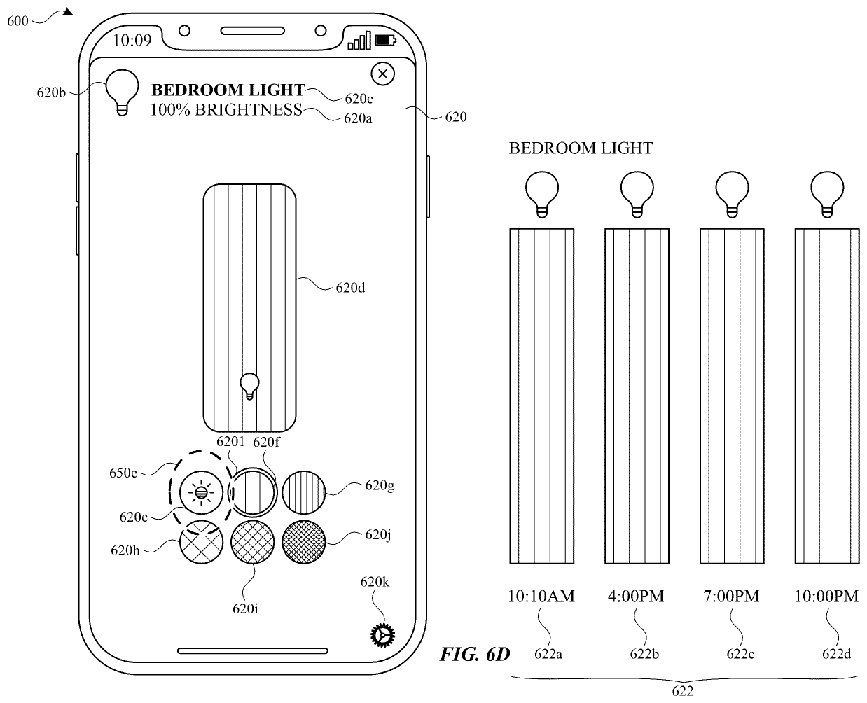

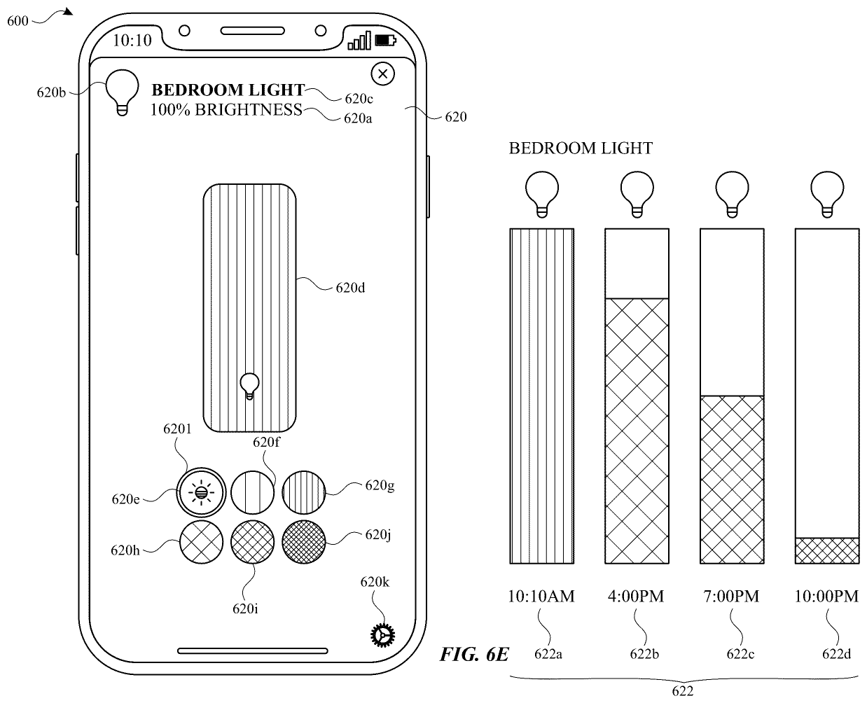

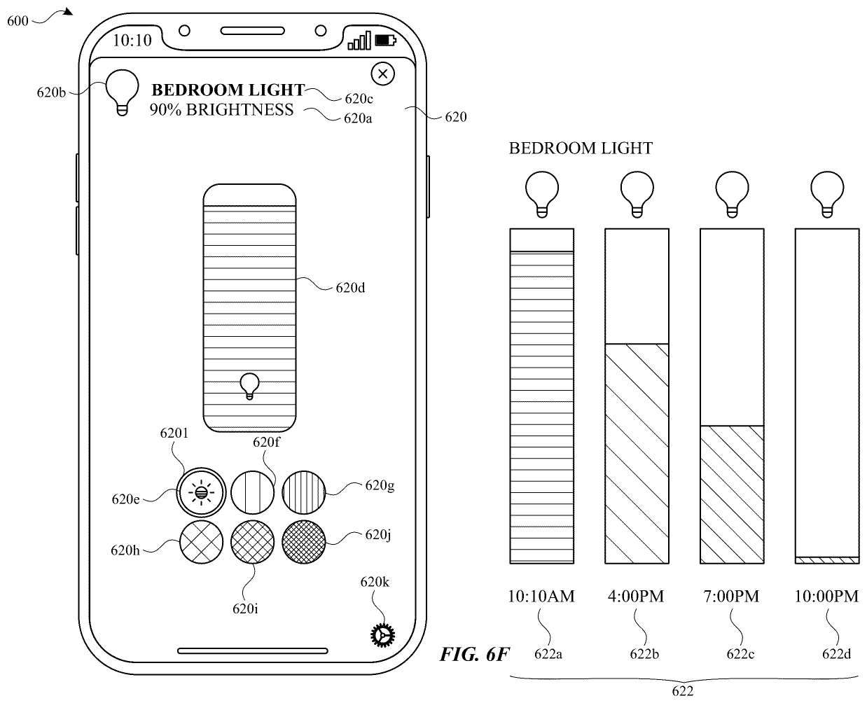

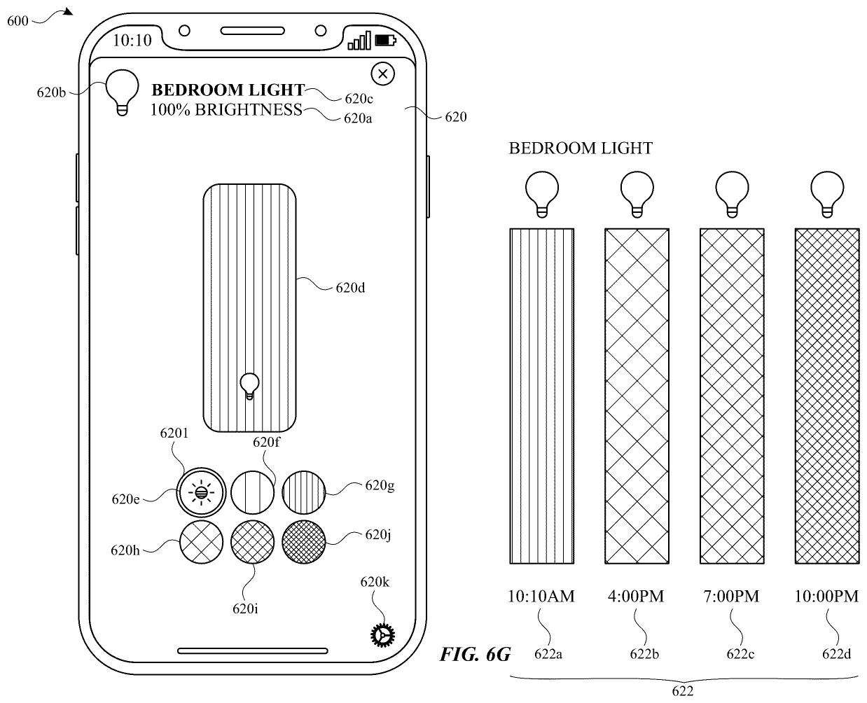

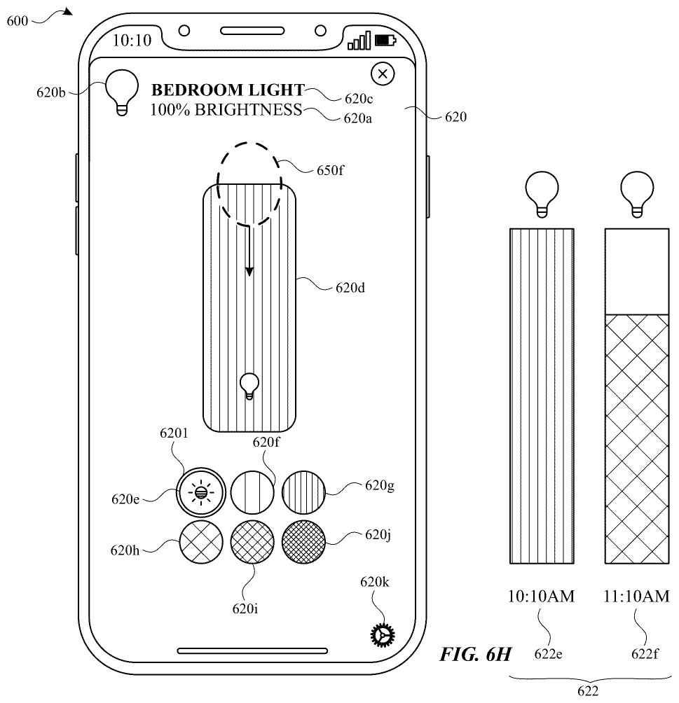

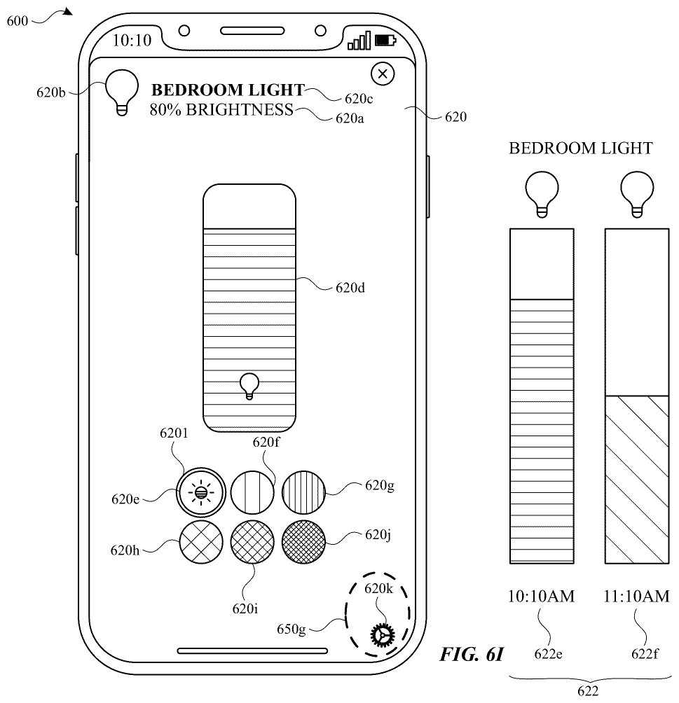

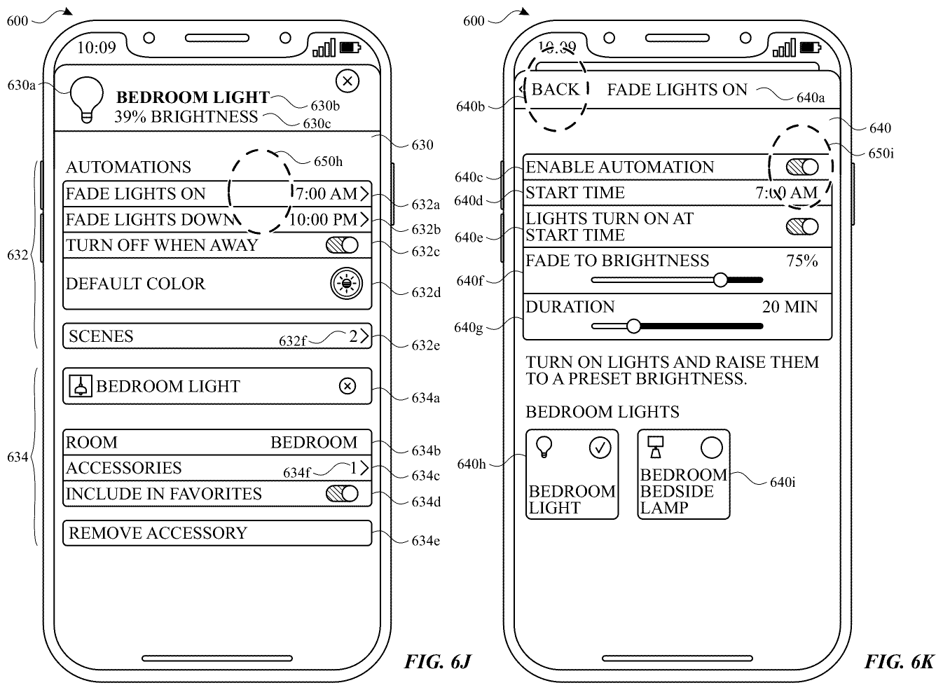

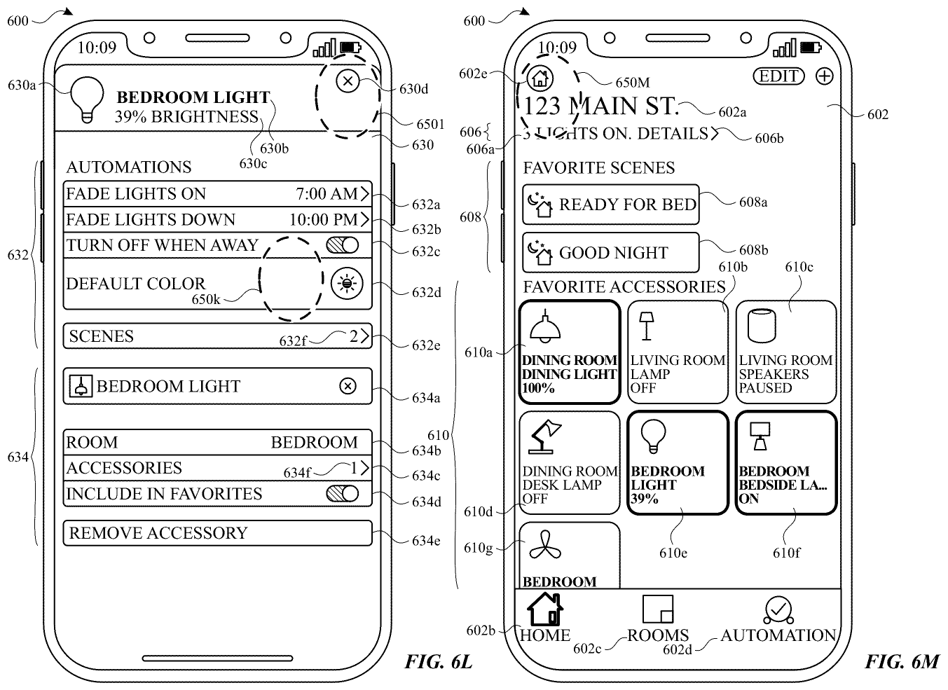

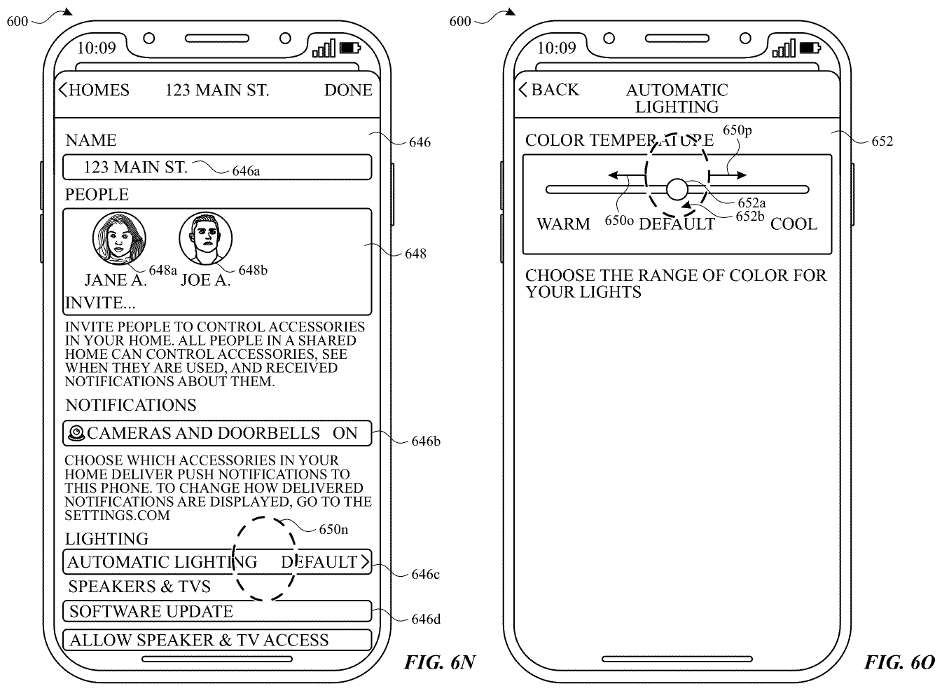

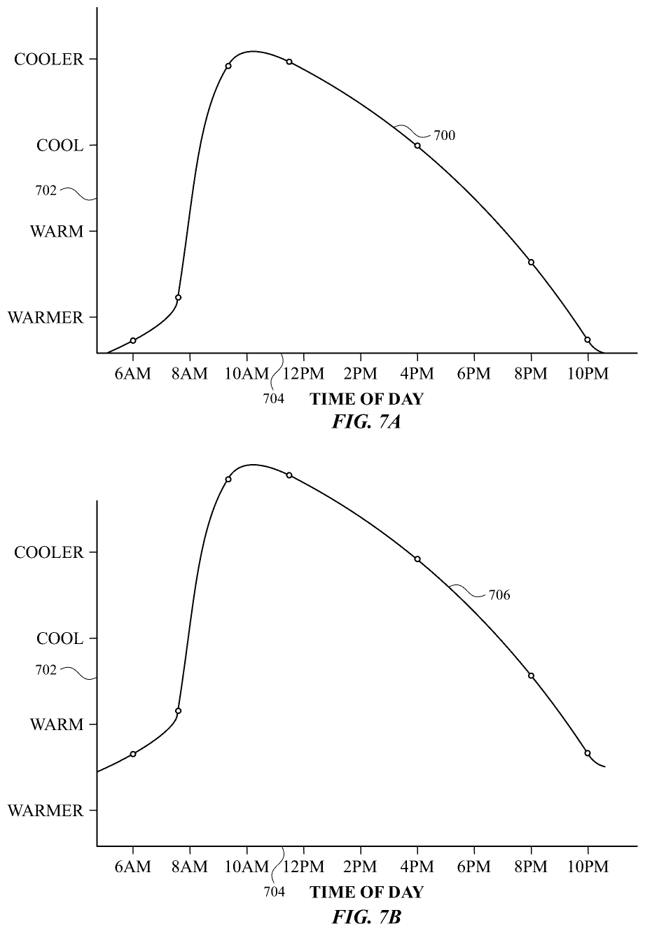

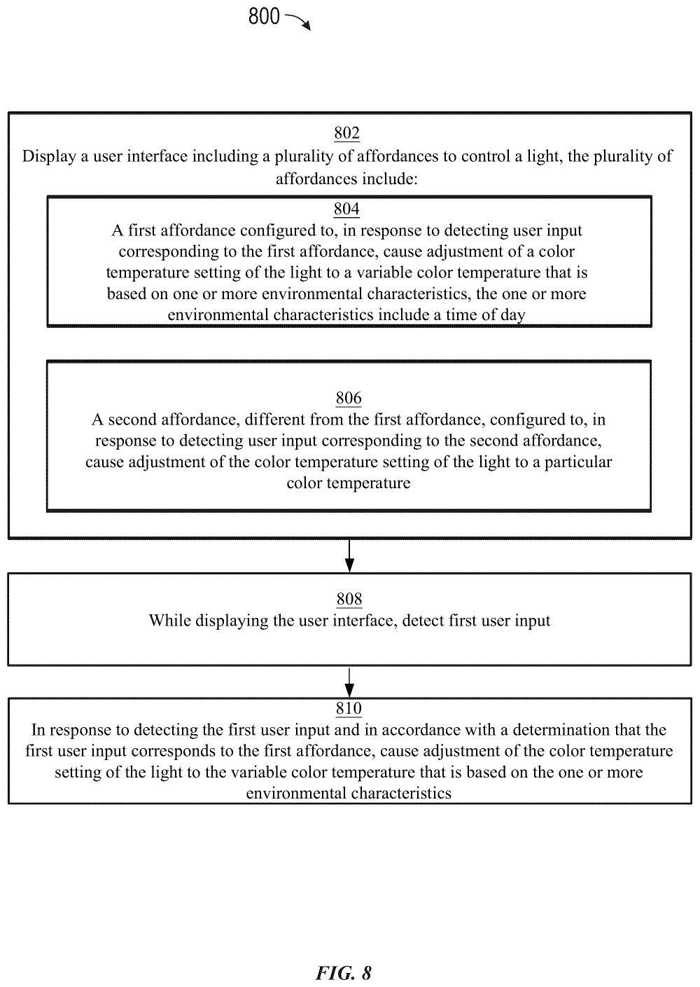

Below, FIGS. 1A-1B, 2, 3, 4A-4B, and 5A-5H provide a description of exemplary devices for performing the techniques for managing event notifications. FIGS. 6A-6O illustrate exemplary user interfaces for managing light accessories. FIGS. 7A-7B illustrate exemplary graphical representations of automated lighting. FIG. 8 is a flow diagram illustrating methods of managing light accessories in accordance with some embodiments. The user interfaces in FIGS. 6A-6O and the graphical representations of FIGS. 7A-7B are used to illustrate the processes described below, including the processes in FIG. 8.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

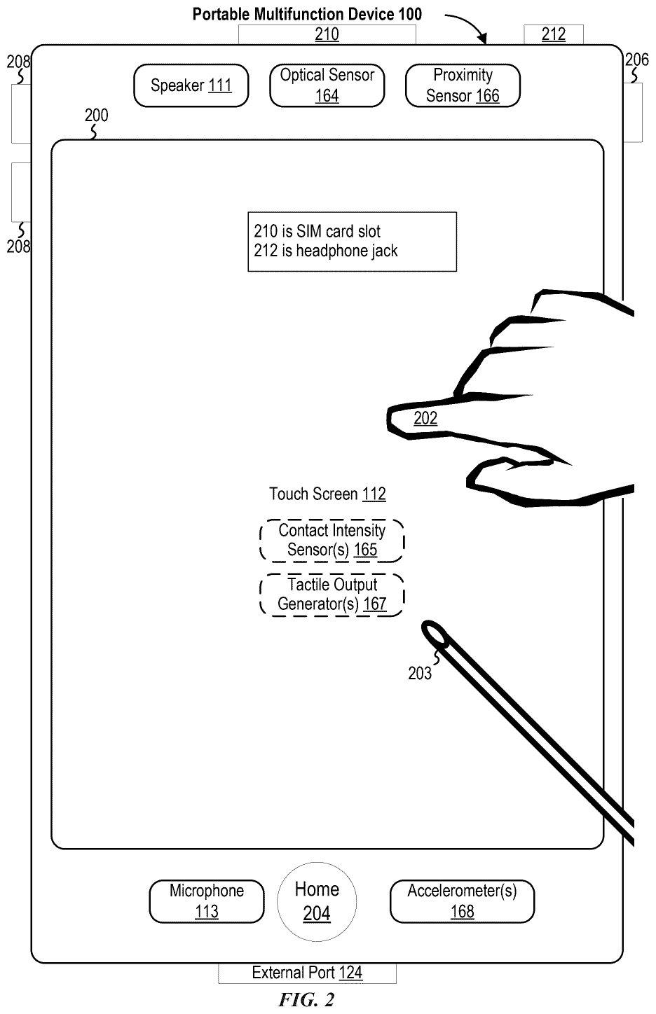

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures) as input. In some embodiments, the one or more input devices are integrated with the computer system. In some embodiments, the one or more input devices are separate from the computer system.

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. Nos. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patents application Ser. Nos. 11/241,839, “Proximity Detector In Handheld Device”; 11/240,788, “Proximity Detector In Handheld Device”; 11/620,702, “Using Ambient Light Sensor To Augment Proximity Sensor Output”; 11/586,862, “Automated Response To And Sensing Of User Activity In Portable Devices”; and 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

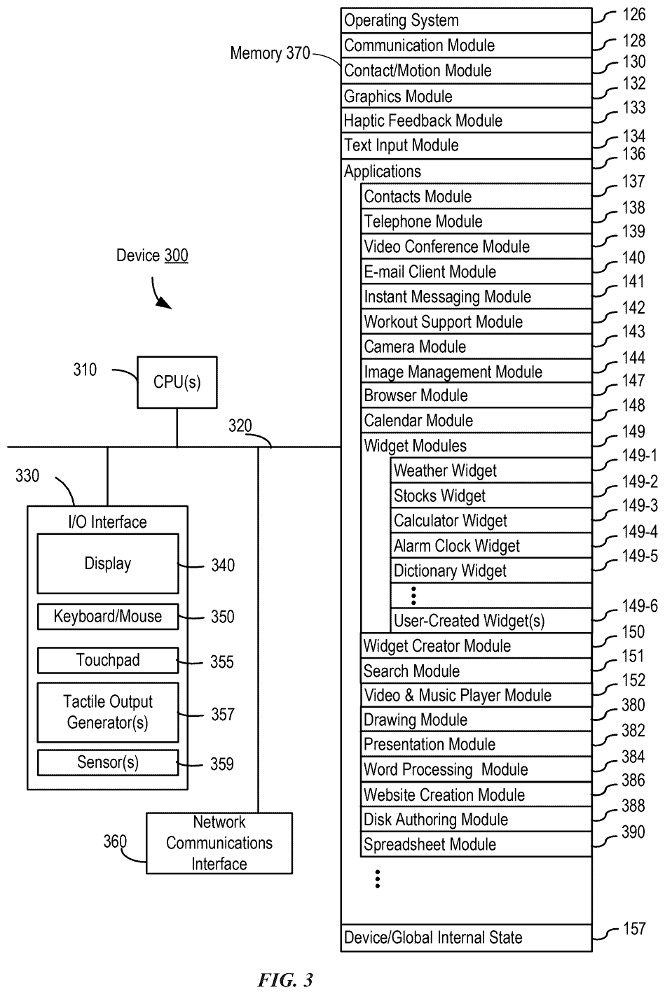

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch” /multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

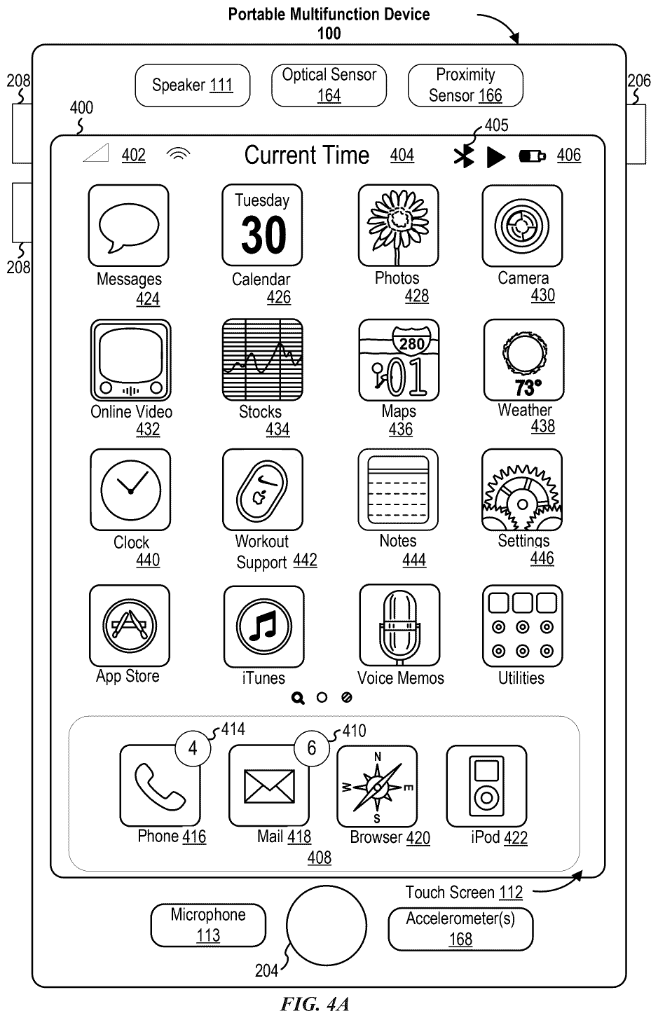

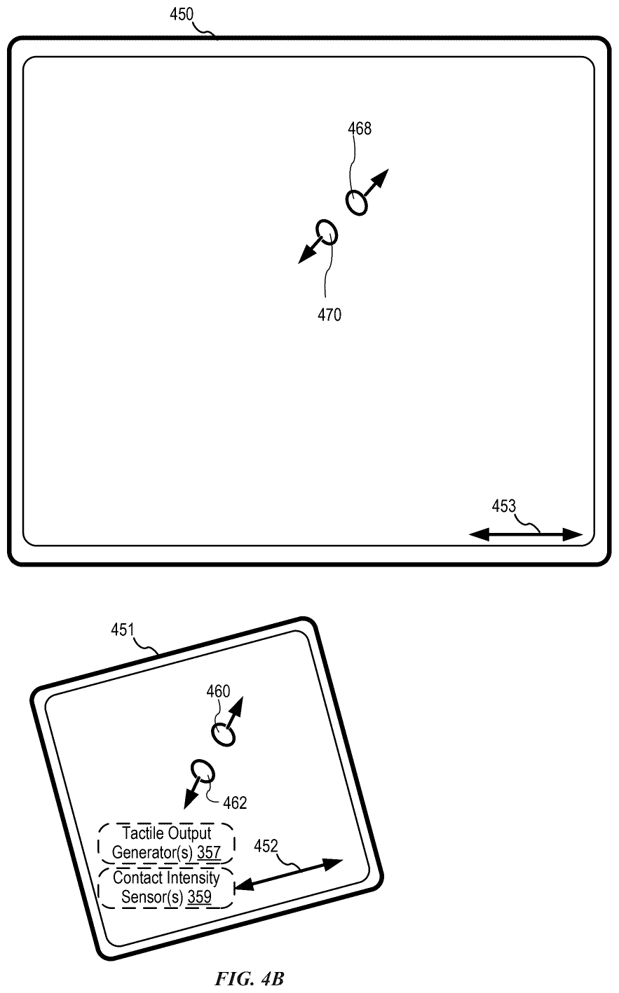

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

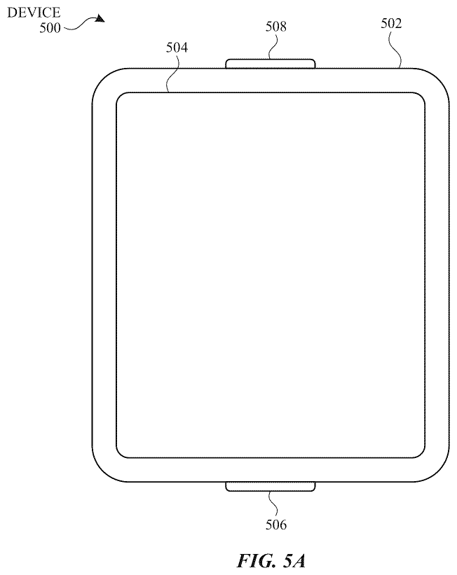

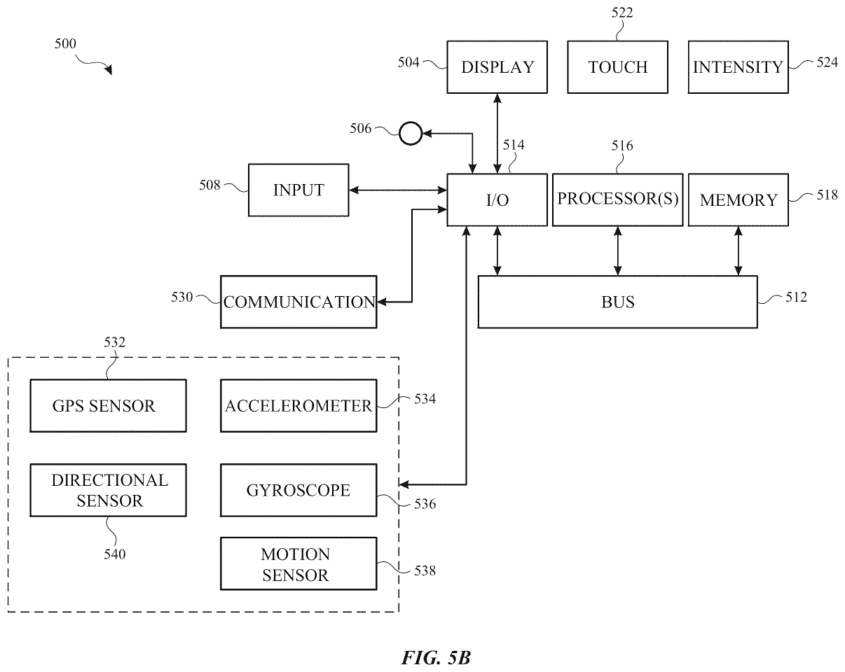

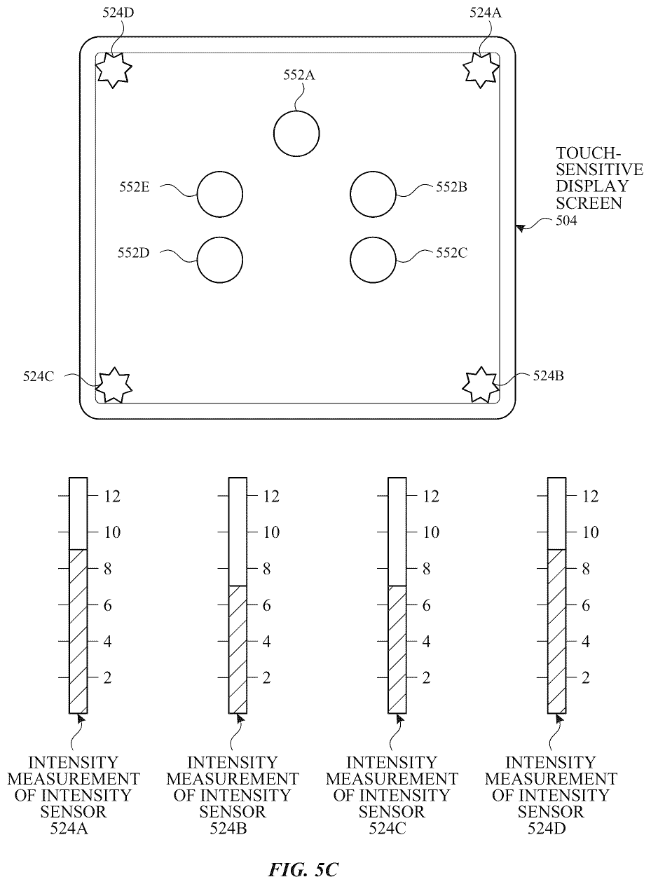

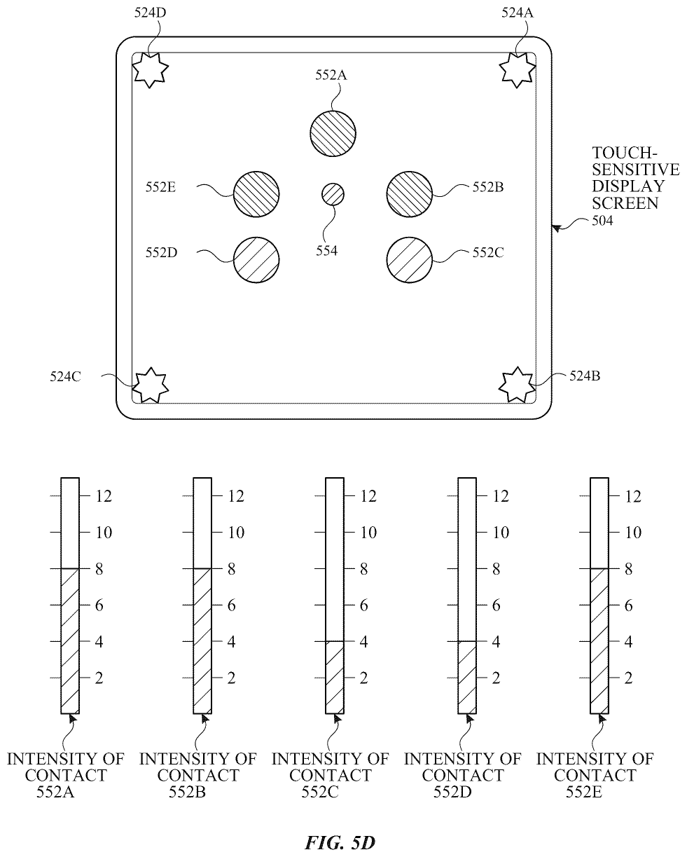

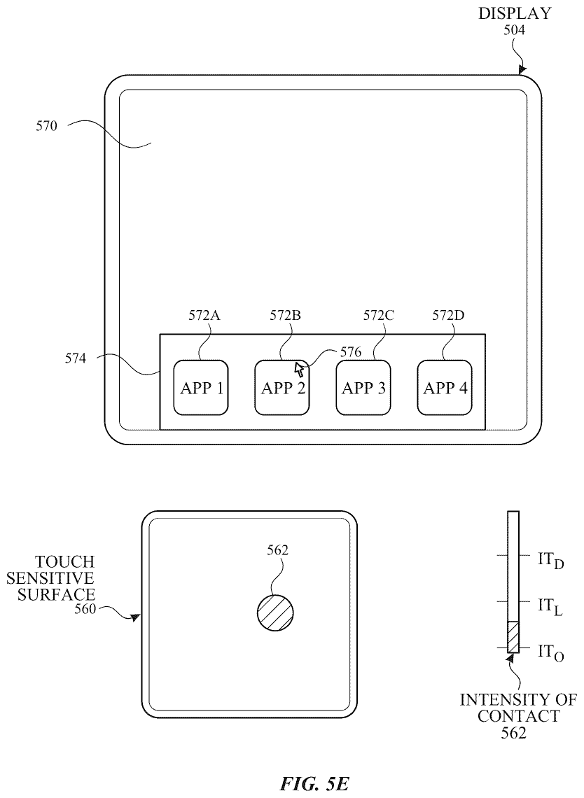

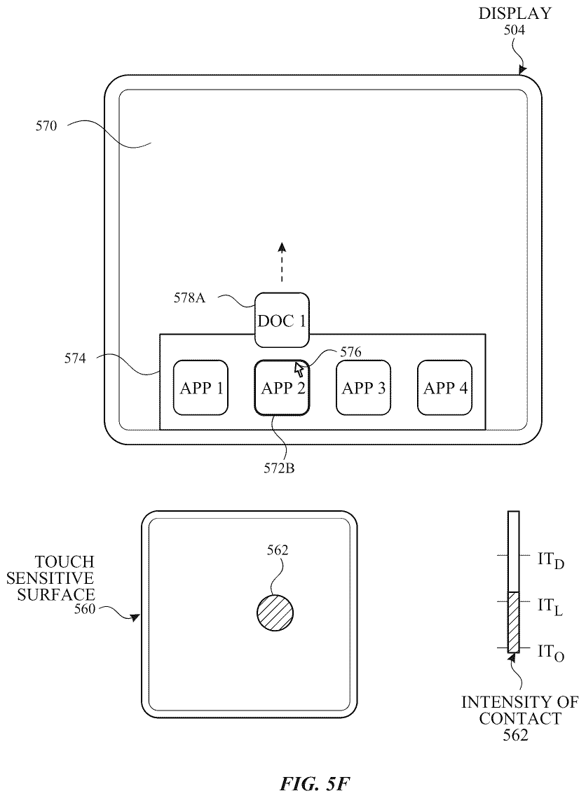

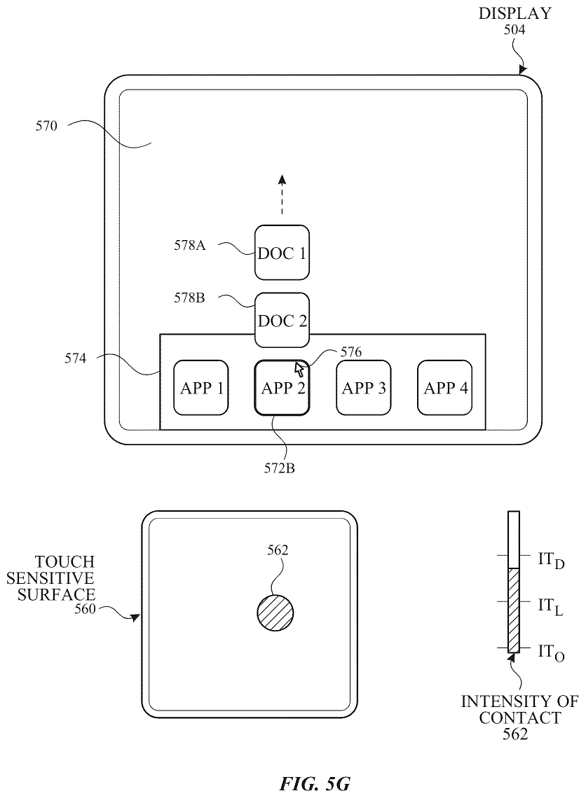

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 800 (FIG. 8). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “ITL”) in FIG. 5E, to an intensity above a deep press intensity threshold (e.g., “ITD”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “ITD”). Contact 562 is maintained on touch-sensitive surface 560. In response to the detection of the gesture, and in accordance with contact 562 having an intensity that goes above the deep press intensity threshold (e.g., “ITD”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “ITD”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

Attention is now directed towards embodiments of user interfaces (“UI”) and associated processes that are implemented on an electronic device, such as portable multifunction device 100, device 300, or device 500.

FIGS. 6A-6O illustrate exemplary user interfaces for managing lighting accessories, in accordance with some embodiments. The user interfaces in these figures are used to illustrate the processes described below, including the processes in FIG. 8.

FIG. 6A illustrates user interface 602 of an application of electronic device 600. The application is for configuring settings of a home automation system, including a light accessory (e.g., a smart lightbulb that is wirelessly connected to the home automation system). At FIG. 6A, user interface 602 includes a name 602a of the home, such as “123 MAIN ST,” notifications area 604, details area 606, automation area 608, accessory area 610, home user interface object 602b, rooms user interface object 602c, and automation user interface object 602d.

Home user interface object 602b is configured to, when activated, cause electronic device 600 to display notifications area 604, details area 606, automation area 608, and accessory area 610 (e.g., transition to user interface 602 when electronic device 600 displays another user interface, maintain user interface 602 when electronic device displays user interface 602). Rooms user interface object 602c is configured to, when activated, cause electronic device 600 to display a user interface having user interface objects corresponding to different rooms of the home and/or accessories associated with (e.g., designated as a part of) the different rooms of the home. Automation user interface object 602d is configured to, when activated, cause electronic device 600 to display a user interface having user interface objects corresponding to controls for adjusting settings related to automated schedules (e.g., adjustments to one or more accessories of the home automation system when a predetermined set of conditions (e.g., times) is met without further user input) for one or more accessories of the home automation system.

Details area 606 includes one or more indicators 606a (e.g., textual indicators, such as “3 LIGHTS ON”) related to a state (e.g., an on state or an off state) of one or more accessories of the home automation system. Details area 606 also includes an additional details user interface object 606b. In response to detection of a user input on additional details user interface object 606b, electronic device 600 displays further information (e.g., textual indicators on user interface 602 or another user interface) related to the accessories (or a subset of accessories) of the home automation system (e.g., which accessories are in an on state and/or settings of the accessories in the on state). Automation area 608 includes one or more user interface objects (e.g., such as user interface object 608a corresponding to READY FOR BED and user interface object 608b corresponding to GOOD NIGHT) that are configured to, when activated, send one or more signals to one or more accessories of the home automation system that cause predetermined adjustments to the one or more accessories. In some embodiments, before displaying the one or more user interface objects of automation area 608, electronic device 600 receives one or more user inputs to configure the predetermined adjustments to the one or more accessories to be performed in response to selection of a corresponding user interface object of automation area 608.

Accessory area 610 includes user interface objects corresponding to accessories of the home automation system (e.g., accessories that have been added to the home automation system and/or designated to be included in accessory area 610). At FIG. 6A, accessory area 610 includes first accessory user interface object 610a (e.g., corresponding to “DINING LIGHT” in “DINING ROOM”), second accessory user interface object 610b (e.g., corresponding to “LAMP” in “LIVING ROOM”), third accessory user interface object 610c (e.g., corresponding to “LIVING ROOM SPEAKERS”), fourth accessory user interface object 610d (e.g., corresponding to “DESK LAMP” in “DINING ROOM”), fifth accessory user interface object 610e (e.g., corresponding to “BEDROOM LIGHT”), and sixth accessory user interface object 610f (e.g., corresponding to “BEDSIDE LAMP” in “BEDROOM”). In some embodiments, accessory area 610 area includes fewer than six or greater than six user interface objects. Further, in some embodiments, in response to a user input (e.g., an upward swipe gesture), electronic device 600 translates user interface 602 to display additional user interface objects in accessory area 610, while ceasing to display other portions of user interface 602 (e.g., notifications area 604 or portions of notifications area 604).

At FIG. 6A, electronic device 600 is configured to, in response to detecting a tap gesture selecting a respective user interface object of accessory area 610, cause adjustment of (e.g., change a state of) a setting (e.g., an on state or an off state) of the corresponding accessory. For example, a tap gesture detected on first accessory user interface object 610a causes electronic device 600 to adjust DINING LIGHT to an off state (e.g., electronic device 600 sends a signal to DINING LIGHT accessory to transition DINING LIGHT accessory from an on state to an off state) because DINING LIGHT is currently in an on state (e.g., bold outline around first accessory user interface object 610a represents an on state; 100% corresponds to a brightness setting of DINING LIGHT; a textual indicator “ON” indicates that DINING LIGHT accessory is in the on state). Similarly, in response to detecting a tap gesture on second accessory user interface object 610b, electronic device 600 causes adjustment of LAMP to an on state (e.g., electronic device 600 sends a signal to LAMP accessory to transition LAMP accessory from an off state to an on state) because LAMP is currently in an off state (e.g., no bold outline around second accessory user interface object 610b represents an off state and “OFF” indicator indicates that LAMP accessory is currently in the off state). As discussed below with reference to FIGS. 6B and 6C, in response to detecting a tap-and-hold gesture on a respective user interface object of accessory area 610, electronic device 600 displays a settings user interface for an accessory corresponding to the respective user interface object.

Notifications area 604 includes notification 612 related to one or more accessories of the home automation system. Notification 612 includes information indicator 612a (e.g., “AUTOMATIC LIGHTING-AUTOMATICALLY ADJUST YOUR LIGHTS BASED ON TIME OF DAY”), first user interface object 612b (e.g., a cancel user interface object), and second user interface object 612c (e.g., “ENABLE” user interface object). In some embodiments, electronic device 600 displays notification 612 in response to the application being launched for a first time after an accessory (e.g., a light accessory that is configurable to a dynamic (or variable) color temperature) is added to (e.g., paired with or otherwise associated with) the home automation system. At FIG. 6A, electronic device 600 detects a tap gesture 650a on second user interface object 612c. In response to detecting tap gesture 650a, electronic device 600 displays user interface 630, as shown at FIG. 6J. Alternatively, electronic device 600 detects tap gesture 650b on first user interface object 612b. In response to detecting tap gesture 650b, electronic device 600 updates user interface 602, as shown in FIG. 6B.

At FIG. 6B, electronic device 600 ceases to display notification 612 in notifications area 604 of user interface 602. As such, selection of first user interface object 612b clears notification 612 and, optionally, does not cause electronic device 600 to perform any further action beyond updating user interface 602 by clearing notification 612 (e.g., electronic device 600 does not perform an action associated with selection of second user interface object 612c). As shown at FIG. 6B, details area 606, automation area 608, and accessory area 610 are translated upward on a screen of electronic device 600 as a result of notification 612 ceasing to be displayed. As such, user interface 602 includes seventh accessory user interface object 610g (e.g., corresponding to “FAN” in “BEDROOM) of accessory area 610. At FIG. 6B, electronic device 600 detects user input 650c (e.g., a long press gesture, a tap-and-hold gesture) on fifth accessory user interface object 610e. In response to detecting user input 650c, electronic device 600 displays user interface 620 as shown at FIG. 6C.

At FIG. 6C, user interface 620 is for configuring settings of an accessory (e.g., a smart light bulb that is connected to the home automation system via a wireless connection, BEDROOM LIGHT) of the home automation system corresponding to fifth accessory user interface object 610e. As shown at FIGS. 6A and 6B, the accessory is in an on state (e.g., as indicated by a border of fifth accessory user interface object 610e being bolded and fifth accessory user interface object 610e including an indicator that the accessory is at an 80% brightness setting). As such, user interface 620 includes setting indicator 620a (e.g., “80% BRIGHTNESS”) indicating that the accessory is in the on state (e.g., emitting light at 80% of full brightness). Further, user interface 620 includes accessory visual indicator 620b (e.g., a light bulb graphic), accessory indicator 620c (e.g., a name of the light accessory, “BEDROOM LIGHT”), brightness setting user interface object 620d, first color temperature user interface object 620e (e.g., a dynamic color temperature UI object), second color temperature user interface object 620f, third color temperature user interface object 620g, fourth color temperature user interface object 620h, fifth color temperature user interface object 620i, sixth color temperature user interface object 620j, and accessory settings user interface object 620k. Brightness setting user interface object 620d indicates the brightness (e.g., using the height (as a percentage) of the filled in bar) and the color temperature (e.g., using color (denoted in FIGS. 6C-6I using hatching) of the filled in bar). Thus, brightness setting user interface object 620d indicates the current brightness and color temperature of the corresponding light accessory being controlled, and visually changes as the brightness and/or color temperature of the corresponding light accessory changes (e.g., because of user input, automated changes based on environmental factors, and scheduled changes) to correspond to the brightness and color temperature of the light accessory.

At FIG. 6C, second color temperature user interface object 620f is currently selected (e.g., via a previous user input, such as a tap gesture, or via a user-defined or system-defined default setting) as indicated by visual indicator 620l (e.g., a ring around second color temperature user interface object 620f). Second color temperature user interface object 620f corresponds to a static color temperature setting (e.g., independent of environmental factors, such as time of day) for the accessory (e.g., BEDROOM LIGHT). As such, when second color temperature user interface object 620f is activated (e.g., selected), electronic device 600 sends one or more signals to the accessory to adjust the color temperature setting to the static color temperature setting (e.g., a first static color temperature setting) associated with second color temperature user interface object 620f. As discussed below, electronic device 600 causes the accessory to maintain the static color temperature setting (e.g., the first static color temperature setting) over time (e.g., absent further user input). In other words, when second color temperature user interface object 620f is activated, the color temperature setting of the accessory is not changed over time without electronic device 600 detecting additional user input.

At FIG. 6C, indicators 622 are provided for a more complete understanding, but are not part of the user interface. Indicators 622 illustrate the brightness and color temperature of the same light bulb at different times throughout the day to provide a more complete understanding of the described techniques. At FIG. 6C, first indicator 622a illustrates a first set of settings (e.g., brightness setting indicated by the height of the filled in bar, color temperature setting indicated by the type of color/hatching in the filled in bar, on/off setting) of the accessory at a first time (e.g., 10:10 AM) on a first day (e.g., the current day). Second indicator 622b illustrates a second set of settings (e.g., brightness setting, color temperature setting, on/off setting) of the accessory at a second time (e.g., 4:00 PM) on the first day. Third indicator 622c illustrates a third set of settings (e.g., brightness setting, color temperature setting, on/off setting) of the accessory at a third time (e.g., 7:00 PM) on the first day. Fourth indicator 622d illustrates a fourth set of settings (e.g., brightness setting, color temperature setting, on/off setting) of the accessory at a fourth time (e.g., 10:00 PM) on the first day. As shown at FIG. 6C, the first set of settings, the second set of settings, the third set of settings, and the fourth set of settings are the same as one another (same brightness, same color temperature). The settings of the accessory are the same because electronic device 600 does not cause adjustment to settings of the accessory over time when second color temperature user interface object 620f is activated (e.g., absent detection of further user input by electronic device 600).

Similar to second color temperature user interface object 620f, third color temperature user interface object 620g, fourth color temperature user interface object 620h, fifth color temperature user interface object 620i, and sixth color temperature user interface object 620j each correspond to static color temperature settings (e.g., different static color temperature settings) that do not cause electronic device 600 to adjust settings of the accessory over time when activated and when electronic device 600 does not detect further user input.

At FIG. 6C, electronic device 600 detects user input 650d (e.g., a swipe gesture) on brightness setting user interface object 620d (e.g., representing a desire to increase the brightness of the bedroom light). In response to detecting user input 650d, electronic device 600 updates user interface 620, as shown at FIG. 6D. Additionally, in response to detecting user input 650d, electronic device causes a brightness setting of the accessory to be adjusted (e.g., by sending one or more signals to the accessory), as indicated by indicators 622 of FIG. 6D. Thus, objects 620f-620j can be used to select a respective static color temperature for the light bulb accessory and the brightness of the light bulb accessory can be selected using brightness setting user interface object 620d.

At FIG. 6D, brightness setting user interface object 620d is modified (e.g., when compared to FIG. 6C) to indicate that brightness setting of the accessory has been adjusted (e.g., from an 80% brightness setting to a 100% brightness setting). Further, setting indicator 620a is updated (e.g., when compared to FIG. 6C) to indicate that the brightness setting of the accessory has been adjusted (e.g., “100% BRIGHTNESS”). Accordingly, the settings illustrated by each of first indicator 622a, second indicator 622b, third indicator 622c, and fourth indicator 622d indicate that the brightness setting of the accessory has been adjusted (e.g., from 80% brightness setting to 100% brightness setting). As set forth above, second color temperature user interface object 620f corresponds to a static color temperature. Thus, while user input 650d causes electronic device 600 to adjust the brightness setting of the accessory (e.g., by sending one or more signals to the accessory), user input 650d does not cause electronic device 600 to adjust the color temperature setting of the accessory either at the time of detecting user input 650d and/or throughout the current day (e.g., over time during the current day).

At FIG. 6D, electronic device 600 detects tap gesture 650e on first color temperature user interface object 620e. In response to detecting tap gesture 650e, electronic device 600 updates display of user interface 620 to reflect selection of first color temperature user interface object 620e (e.g., indicated by visual indicator 6201), as shown at FIG. 6E.

First color temperature user interface object 620e corresponds to an automated lighting feature for the accessory (e.g., BEDROOM LIGHT) of the home automation system corresponding to fifth accessory user interface object 610e in FIG. 6A. The automated lighting feature is an automated technique that adjusts settings of the accessory over time without user input (e.g., without further user input beyond tap gesture 650e). When first color temperature user interface object 620e is activated, electronic device 600 causes adjustment of settings of the accessory based on one or more environmental characteristics. The one or more environmental characteristics optionally include one or more of: current time of day, current time of year, location of the accessory, home automation system, or electronic device 600, current weather at the location of accessory, home automation system, or electronic device 600, and/or predominant colors in an environment in which the accessory is located (e.g. at least one color of a room (e.g., a paint color of walls in the room and/or a blend of colors of objects in the room) in which the accessory is located, at least one color associated with a location of a building in which the accessory is located (e.g., cooler colors for a metropolitan location versus warmer colors for a rural location), and/or at least one color of an object nearest to the light in a room in which the light is located). In response to detecting tap gesture 650e, electronic device 600 sends one or more signals to the accessory to cause adjustment of one or more settings (e.g., color temperature setting and/or brightness setting) of the accessory over time based on the environmental characteristics.

In some embodiments, electronic device 600 sends a single signal to the accessory to initiate and implement the automated lighting feature (e.g., the single signal includes instructions to adjust the settings of the accessory at different times of a day). In some embodiments, electronic device 600 sends a signal to the accessory at a predetermined time interval (e.g., every second, every minute, every 10 minutes, every 30 minutes, every hour) to cause adjustment of the settings of the accessory based on the one or more environmental characteristics. In some embodiments, electronic device 600 sends a continuous signal (e.g., electronic device 600 and the accessory are in constant communication with one another) to the accessory to cause adjustment of the settings of the accessory based on the one or more environmental characteristics.

At FIG. 6E, indicators 622 illustrate that, in response to electronic device 600 detecting tap gesture 650e, the settings (e.g., a brightness setting and/or a color temperature setting) of the accessory are adjusted throughout the day based on the one or more environmental characteristics. For instance, first indicator 622a represents a first set of settings of the accessory at 10:1 0AM on a second day (e.g., the current day). First indicator 622a indicates that accessory (e.g., BEDROOM LIGHT) is at a first color temperature setting (e.g., represented by first hatching at FIG. 6E) and a first brightness setting (e.g., 100% brightness setting) at 10:10 AM on the second day. Second indicator 622b represents a second set of settings of the accessory at 4:00 PM on the second day. Second indicator 622b indicates that accessory is at a second color temperature setting (e.g., represented by second hatching at FIG. 6E), different from the first color temperature, and a second brightness setting (e.g., 80% brightness setting), different from the first brightness setting, at 4:00 PM on the second day. Third indicator 622c represents a third set of settings of the accessory at 7:00 PM on the second day. Third indicator 622c indicates that accessory is at a third color temperature setting (e.g., represented by third hatching at FIG. 6E), different from the first and second color temperature settings, and a third brightness setting (e.g., 50% brightness setting), different from the first and second brightness settings, at 7:00 PM on the second day. Further still, fourth indicator 622d represents a fourth set of settings of the accessory at 10:00 PM on the second day. Fourth indicator 622d indicates that accessory is at a fourth color temperature setting (e.g., represented by fourth hatching at FIG. 6E), different from the first, second, and third color temperature settings, and a fourth brightness setting (e.g., 10% brightness setting), different from the first, second, and third brightness settings, at 10:00 PM on the second day. Thus, electronic device 600 varies the color temperature and the brightness of the light accessory as time progresses.

When first color temperature user interface object 620e is activated, settings of the accessory are adjusted automatically without the user providing additional inputs to electronic device 600. The settings of the accessory are adjusted throughout the day based on the one or more environmental characteristics. In some embodiments, the settings of the light are adjusted to emulate (or correspond to) natural light occurring in an outdoor environment where the accessory (and/or the home automation system and electronic device 600) is located. As such, the color temperature setting of the accessory is adjusted to begin at warmer color temperatures in the morning, transition to cooler color temperatures during the middle of the day, and transition back to warmer color temperatures in the evening/night. Additionally, the brightness setting of the accessory is adjusted to decrease as the brightness of natural light in the outdoor environment decreases.

As set forth above, adjustment of the settings of the accessory when first color temperature user interface object 620e is activated is based on one or more environmental characteristics. Thus, a range of settings of the accessory (e.g., range of color temperature settings and/or range of brightness settings) is different on any given day based on the one or more environmental characteristics when first color temperature user interface object 620e is activated. For example, FIG. 6F illustrates user interface 620 with first color temperature user interface object 620e activated on a third day (e.g., different from the second day), at a location different from a location of the accessory in the example of FIG. 6E, and/or on the second day with different weather conditions when compared to the example of FIG. 6E (e.g., weather occurring in the outdoor environment for the example of FIG. 6F is different from the weather occurring in the outdoor environment for the example of FIG. 6E).

As shown by indicators 622 at FIG. 6F, settings (e.g., a brightness setting and/or a color temperature setting) of the accessory are adjusted throughout the day based on the one or more environmental characteristics. For instance, first indicator 622a represents a fifth set of settings of the accessory at 10:10 AM on a third day (e.g., the current day, the second day, and/or a day different from the second day). First indicator 622a indicates that accessory (e.g., BEDROOM LIGHT) is at a fifth color temperature setting (e.g., represented by fifth hatching at FIG. 6F), different from the first color temperature setting, and a fifth brightness setting (e.g., 90% brightness setting) at 10:10 AM on the third day. Second indicator 622b represents a sixth set of settings of the accessory at 4:00 PM on the third day. Second indicator 622b indicates that accessory is at a sixth color temperature setting (e.g., represented by sixth hatching at FIG. 6F), different from the second and fifth color temperature settings, and a sixth brightness setting (e.g., 65% brightness setting), different from the fifth brightness setting, at 4:00 PM on the third day. Third indicator 622c represents a seventh set of settings of the accessory at 7:00 PM on the third day. Third indicator 622c indicates that accessory is at a seventh color temperature setting (e.g., represented by seventh hatching at FIG. 6E), different from the third, fifth, and sixth color temperature settings, and a seventh brightness setting (e.g., 30% brightness setting), different from the fifth and sixth brightness settings, at 7:00 PM on the third day. Further still, fourth indicator 622d represents an eighth set of settings of the accessory at 10:00 PM on the third day. Fourth indicator 622d indicates that accessory is at an eighth color temperature setting (e.g., represented by eighth hatching at FIG. 6E), different from the fourth, fifth, sixth, and seventh color temperature settings, and an eighth brightness setting (e.g., 5% brightness setting), different from the fifth, sixth, and seventh brightness settings, at 10:00 PM on the third day. Thus, electronic device 600 adjusts the color temperatures and brightness of the same light accessory differently based on the day of the year and/or the current weather. Further, the color temperatures and brightness can be based on location information (e.g., longitude and/or latitude).

Accordingly, adjustment of the settings of the accessory is based on the one or more environmental factors (e.g., time of day, time of year, location, weather patterns), which can cause the range of settings (e.g., a range of color temperature settings and/or a range of brightness settings) of the accessory to differ on different days of the year, in different locations around the world, and/or during different weather conditions.

In some embodiments, one or more of the settings of the accessory are not adjusted based on the one or more environmental characteristics throughout the day when first color temperature user interface object 620e is activated. For example, at FIG. 6G, electronic device 600 causes adjustment of the color temperature setting of the accessory based on the one or more environmental characteristics, but not the brightness setting, when first color temperature user interface object 620e is activated. Accordingly at FIG. 6G, first indicator 622a, second indicator 622b, third indicator 622c, and fourth indicator 622d each indicate a brightness setting of the accessory at 100% (e.g., electronic device 600 does not cause adjustment to the brightness setting of the accessory throughout the day without detecting further user input (e.g., user input on brightness setting user interface object 620d)). While FIG. 6G shows the brightness setting of the accessory at 100% throughout the day (e.g., at 10:10 AM, at 4:00 PM, at 7:00 PM, and at 10:00 PM), the brightness setting may be set at any percentage set by the user (e.g., using slider, such as brightness setting user interface object 620d) or defined by electronic device 600 (e.g., a default brightness setting) throughout the day.

In some embodiments, electronic device 600 detects user input on brightness setting user interface object 620d while first color temperature user interface object 620e is activated. In response to detecting user input on brightness setting user interface object 620d, electronic device 600 causes adjustment of the brightness setting of the accessory when first color temperature user interface object 620e is activated, but does not cause further adjustments of the brightness setting of the accessory at future times during the day and/or based on the one or more environmental characteristics.

In some embodiments, in response to detecting user input on brightness setting user interface object 620d when first color temperature user interface object 620e is activated, electronic device causes adjustment of the brightness setting of the accessory as well as adjustment to the color temperature setting. In other words, adjustment of the color temperature setting of the accessory when first color temperature user interface object 620e is activated is based on both the one or more environmental characteristics and the brightness setting of the accessory (e.g., a change in brightness setting resulting from user input), as shown at FIGS. 6H and 6I.

At FIG. 6H, electronic device 600 displays user interface 620 when first color temperature user interface object 620e activated. At FIG. 6H, fifth indicator 622e and sixth indicator 622f correspond to settings of the accessory at different times of a day when electronic device 600 does not detect user input on brightness setting user interface object 620d. Fifth indicator 622e represents a ninth set of settings of the accessory at a first time (e.g., 10:10 AM) on a fourth day. Fifth indicator 622e indicates that accessory is at the fifth color temperature setting and a 100% brightness setting at 10:10 AM on the fourth day. Further, sixth indicator 622f represents a tenth set of settings of the accessory at a second time (e.g., 11:10 AM) on the fourth day. Sixth indicator 622f indicates that accessory is at the sixth color temperature setting and a 75% brightness setting at 11:10 AM on the fourth day. Accordingly, when first color temperature user interface object 620e is activated and without further user input, electronic device 600 causes adjustment of the color temperature setting and brightness setting of the accessory between the first time and the second time on the fourth day (e.g., by sending one or more signals to the accessory between the first time and the second time).

At FIG. 6H, electronic device 600 detects user input 650f (e.g., a swipe down gesture) on brightness setting user interface object 620d (e.g., representing a desire to decrease the brightness of the bedroom light). In response to detecting user input 650f, electronic device 600 updates display of user interface 620, as shown at FIG. 6I. At FIG. 6I, brightness setting user interface object 620d is updated to indicate a reduced brightness setting of the accessory at 10:10 AM on the fourth day.

At FIG. 6I, a portion of shading within the brightness setting user interface object 620d is removed to indicate the reduced brightness setting resulting from user input 650f. Further, electronic device 600 causes adjustment to the brightness setting of the accessory in response to receiving user input 650f, as shown by fifth indicator 622e. Electronic device 600 also causes adjustment of the color temperature setting of the accessory in response to receiving user input 650f at the first time (e.g., 10:10 AM) on the fourth day. Fifth indicator 622e represents the settings of the accessory at the first time on the fourth day after electronic device 600 causes adjustment to the settings (e.g., color temperature setting and brightness setting) of the accessory in response to user input 650f. At FIG. 6I, fifth indicator 622e indicates that accessory is at a reduced brightness setting when compared to the brightness setting at the first time on the fourth day shown in the example at FIG. 6H (e.g., brightness setting is reduced from 100% to 80%) and that the accessory is at the first color temperature setting as opposed to the fifth color temperature setting shown in the example at FIG. 6H. Accordingly, in some embodiments, in response to detecting user input 650f to adjust the brightness setting of the accessory, electronic device 600 automatically (e.g., without further user input beyond user input 650f) causes adjustment of the color temperature of the accessory in addition to adjustment of the brightness setting. Adjusting the color temperature setting of the accessory automatically in response to user input adjusting brightness setting optionally enables light emitted from the accessory to more closely resemble natural light occurring at an outdoor environment where the accessory is located.

Further, because first color temperature user interface object 622e is activated, the brightness setting and the color temperature setting of the accessory may also be adjusted at later times during the day (e.g., without further user input beyond user input 650f). At FIG. 6I, sixth indicator 622f indicates that accessory is at the second color temperature setting instead of the sixth color temperature setting shown in the example at FIG. 6H and at a reduced brightness setting (e.g., 45%) when compared to the brightness setting at the second time on the fourth day shown in the example at FIG. 6H. Accordingly, in response to user input 650f, electronic device 600 causes adjustment of the brightness setting and color temperature setting of the accessory at the time user input 650f is detected, as well as at times following detection of user input 650f.

At FIG. 6I, electronic device 600 detects tap gesture 650g on accessory settings user interface object 620k. In response to detecting tap gesture 650g, electronic device displays user interface 630, as shown at FIG. 6J. User interface 630 is for configuring settings related to automations (e.g., automated schedules) for the accessory (e.g., BEDROOM LIGHT). For example, user interface 630 enables configuration of alarms and/or other automated scheduling of the accessory upon detecting one or more user inputs. User interface 630 includes visual indicator 630a (e.g., a light bulb graphic), accessory indicator 630b (e.g., “BEDROOM LIGHT”), setting indicator 630c (e.g., “39% BRIGHTNESS”), automation settings area 632, and room settings area 634.

Automation settings area 632 is for configuring one or more automated schedules for the accessory (and/or other accessories associated with a room in which the accessory is designated). Automation settings area 632 includes start time user interface object 632a, stop time user interface object 632b, away setting user interface object 632c, default color user interface object 632d, and scenes user interface object 632e. As set forth below, tap gesture 650h on start time user interface object 632a causes electronic device 600 to display user interface 640, which enables a user to specify times and other settings for initiating an automated schedule for the accessory (e.g., transitioning the accessory to an on state). Similarly, tap gesture on stop time user interface object 632b causes electronic device 600 to display another user interface that enables a user to specify times and other settings for ending an automated schedule for the accessory (e.g., transitioning the accessory to an off state).

Away user interface object 632c is configured to maintain or disable an automated schedule when a user of electronic device 600 is away from the home of the home automation system (e.g., using a geofence). For example, when the user of electronic device 600 is absent from their home (e.g., on vacation) and away user interface object 632c is activated, the automated schedule is disabled to maintain the accessory in an off state, thereby saving power. Default color user interface object 632d is configured to enable a user to select a default color temperature setting for the accessory. Default color user interface object 632d and the default color temperature setting are discussed in further detail below with reference to FIG. 6L. Scenes user interface object 632e is for configuring additional automated schedules for the accessory (e.g., causing adjustment of settings of the accessory when one or more set of criteria are met). For instance, user input on scenes user interface object 632e enables the user of electronic device 600 to provide settings for one or more automated schedules. In some embodiments, upon creating an automated schedule using scenes user interface object 632e, electronic device 600 displays a user interface object corresponding to the automated schedule in automation area 608 of user interface 602. Further, scenes user interface object 632e displays an indicator 632f indicating a number of (e.g., additional) automated schedules associated with the accessory.

Room settings area 634 of user interface 630 includes first accessory user interface object 634a (e.g., labeled “BEDROOM LIGHT”), room user interface object 634b, room accessories user interface object 634c, favorites user interface object 634d, and remove accessory user interface object 634e. First accessory user interface object 634a corresponds to a first accessory (e.g., BEDROOM LIGHT) that is associated with a particular room of the home having the home automation system. In some embodiments, additional accessory user interface objects may be displayed with first accessory user interface object 634a as electronic device 600 receives user input to designate other accessories to the room (e.g., BEDROOM). Room user interface object 634b indicates a name (e.g., BEDROOM) of the room in which the accessory has been designated. Room accessories user interface object 634c includes indicator 634f indicating a number of accessories designated to the room (e.g., “1”). In some embodiments, receiving user input corresponding to room accessories user interface object 634c causes electronic device 600 to display a user interface and/or user interface objects associated with each accessory designated within the room (e.g., visual indicators of each accessory designated as part of the room). Favorites user interface object 634d is configured to, when activated, enable or disable display of the accessory in accessory area 610 of user interface 602. For example, in response to a tap gesture on favorites user interface object 634d when favorites user interface object 634d is deactivated, electronic device 600 displays a user interface object in accessory area 610 of user interface 602. Remove accessory user interface object 634e is configured to, when activated, remove the accessory from the home automation system. Thus, in response to receiving a tap gesture on remove accessory user interface object 634e, electronic device 600 causes removal of the accessory from the home automation system, thereby preventing control of the accessory via electronic device 600.

As set forth above, at FIG. 6J, electronic device 600 detects tap gesture 650h on start time user interface object 632a. In response to detecting tap gesture 650h, electronic device 600 displays user interface 640, as shown at FIG. 6K. At FIG. 6K, user interface 640 includes start time indicator 640a (e.g., “FADE LIGHTS ON”), back user interface object 640b (e.g., “BACK” affordance), enable automation user interface object 640c, set start time user interface object 640d, use start time user interface object 640e, fade user interface object 640f, fade duration user interface object 640g, first room accessory user interface object 640h, and second room accessory user interface object 640i.

Enable automation user interface object 640c is configured to, when activated, enable or disable an automated schedule for the accessory. Tap gesture 650i activates enable automation user interface object 640c, thereby causing electronic device 600 to send one or more signals to the accessory to perform the automated schedule (e.g., an automated schedule for adjusting settings of the accessory when one or more criteria are met). Set start time user interface object 640d is configured to, when selected or activated, enable electronic device 600 to receive one or more user inputs corresponding to a start time for the automated schedule. For example, a user of electronic device 600 can select a time when the user wakes up as the start time for the automated schedule, such that the accessory transitions to an on state at the start time to facilitate waking up the user. Use start time user interface object 640e provides an option for the automated schedule to begin at the time selected by the user of electronic device 600, when activated, or to begin at another predetermined time (e.g., sunrise), when not activated. Fade user interface object 640g is configured to, in response to user input (e.g., slide or swipe gestures), enable the user to select a brightness setting to which the accessory is ultimately adjusted (e.g., brightness setting of accessory gradually increases to the selected brightness setting at the start time). Fade duration user interface object 640g, is configured to, in response to user input (e.g., slide or swipe gesture), enable the user to select a duration (e.g., time period beginning at the start time and ending when the accessory reaches the selected brightness setting) for the accessory to reach the selected brightness setting (e.g., the brightness setting selected via fade user interface object 640g). First room user interface object 640h corresponds to the accessory (e.g., BEDROOM LIGHT) and second user interface object 640i corresponds to an additional accessory (e.g., BEDROOM BEDSIDE LAMP) that has been designated as part of the room (e.g., BEDROOM).

At FIG. 6K, electronic device 600 detects tap gesture 650j on back user interface object 640b. In response to detecting tap gesture 650j, electronic device displays user interface 630, as shown at FIG. 6L. At FIG. 6L, electronic device detects tap gesture 650k on default color user interface object 632d. In response to detecting tap gesture 650k, electronic device 600 displays one or more user interface objects corresponding to options for a default color temperature setting of the accessory. The default color temperature setting of the accessory is a color temperature setting of the accessory that occurs when the accessory transitions from an off state to an on state (e.g., when the accessory is turned on). In some embodiments, one or more user interface objects corresponding to options of the default color temperature setting of the accessory include: (1) a last used color temperature setting (e.g., a color temperature setting of the accessory at the time the accessory was most recently turned off), (2) a white color temperature setting (e.g., a white color temperature setting having an offset based on user input, as described below with respect to FIG. 60), (3) a dynamic color temperature setting (e.g., a color temperature setting that is based on the one or more environmental characteristics, as described in additional detail above), and/or (4) a static color temperature setting (e.g., a color temperature setting selected by the user or defined by electronic device that does not change and/or is not based on the one or more environmental characteristics).

At FIG. 6L, electronic device 600 detects tap gesture 650l on close user interface object 630d. In response to detecting tap gesture 650l, electronic device displays user interface 602, as shown at FIG. 6M. At FIG. 6M, electronic device 600 detects tap gesture 650m on home settings user interface object 602e. In response to detecting tap gesture 650m, electronic device 600 displays user interface 646, as shown at FIG. 6N. User interface 646 includes a name 646a of the home, such as “123 MAIN ST,” indications 648 of multiple users (Jane 648a, Joe 648b) who are members of the home (e.g., have rights to modify settings of accessories corresponding to the home), camera user interface object 646b for configuring settings of camera accessories that are part of the home automation system, lighting user interface object 646c for configuring settings of light accessories that are part of the home automation system, and multimedia user interface object 646d for configuring settings of multimedia accessories (e.g., speakers and televisions) that are part of the home automation system.

At FIG. 6N, electronic device 600 detects tap gesture 650n on lighting user interface object 646c. In response to detecting tap gesture 650n, electronic device displays user interface 652, as shown at FIG. 60. User interface 652 includes offset user interface object 652aconfigured to apply an offset to the color temperature settings of the accessory (e.g., when first color temperature user interface object 620e is activated). For example, when first color temperature user interface object 620e is activated, electronic device 600 causes adjustment to the color temperature setting of the accessory throughout the day (e.g., to resemble natural light present outdoors in a location of the accessory/electronic device 600). In response to left swipe gesture 650o on offset user interface object 652a, electronic device 600 causes an offset adjustment to each color temperature setting of the accessory throughout the day (e.g., a range of color temperature settings) to a warmer color temperature setting (e.g., warmer color temperature settings throughout the day when compared to offset user interface object 652a being positioned at default position 652b) for the dynamic color temperature option (e.g., corresponding to 620e), without changing the static color options (e.g., corresponding to 620f-620j). Similarly, in response to right swipe gesture 650p on offset user interface object 652a, electronic device 600 causes an offset adjustment to each color temperature setting of the accessory throughout the day (e.g., a range of color temperature settings) to a cooler color temperature setting (e.g., cooler color temperature settings throughout the day when compared to offset user interface object 652a being positioned at default position 652b) for the dynamic color temperature option (e.g., corresponding to 620e), without changing the static color options (e.g., corresponding to 620f-620j). Accordingly, a user of electronic device 600 is able to configure a preferred range of color temperature settings that the accessory adjusts to throughout the day when the dynamic color temperature option is selected.

Turning now to FIGS. 7A and 7B, FIG. 7A illustrates a graphical representation 700 of the color temperature setting 702 of the accessory at different times 704 of a first day (e.g., a single day) when the dynamic color temperature option is selected. At FIG. 7A, offset user interface object 652a is at default position 652b (e.g., electronic device 600 does not cause an offset adjustment to the color temperature settings of the accessory throughout the day). In some embodiments, the accessory follows an automated schedule that transitions the accessory from an off state to an on state at the beginning of the day (e.g., 5:00 AM). In some embodiments, the accessory transitions from the off state to the on state based on user input and the color temperature setting of the accessory is adjusted to the color temperature setting corresponding to the time the user input is detected (e.g., by electronic device 600). At FIG. 7A, color temperature setting 702 starts at warmer color temperature settings at the beginning of the day and the color temperature setting 702 rapidly becomes cooler in the late morning (e.g., at 8:00 AM). After reaching a maximum cool color temperature setting (e.g., at 10:00 AM), the color temperature setting 702 progressively becomes warmer.

As set forth above, a position of offset user interface object 652a and the one or more environmental characteristics (e.g., time of year, location, weather) affect the range of color temperature settings of the accessory on a given day. For example, FIG. 7B illustrates graphical representation 706 of the color temperature setting 702 of the accessory at different times 704 of a second day (e.g., different from the first day). At FIGS. 7A and 7B, the range of color temperature settings of graphical representation 706 is shifted (e.g., offset) upwards (e.g., toward cooler color temperature settings) when compared to the range of color temperature settings of graphical representation 700.

In some embodiments, graphical representation 706 corresponds to a range of color temperature settings of the accessory during a different time of year (and at a same location) as compared to the range of color temperature settings of graphical representation 700. In some embodiments, graphical representation 706 corresponds to a range of color temperature settings of the accessory at a different location (and at a same time of year) as compared to the range of color temperatures of graphical representation 700. In some embodiments, graphical representation 706 corresponds to a range of color temperature settings of the accessory on the same day and at the same location, but with different weather patterns, as compared to the range of color temperatures of graphical representation 700. In some embodiments, graphical representation 706 corresponds to a range of color temperatures of the accessory when electronic device 600 detects right swipe gesture 650p and graphical representation 700 corresponds to a range of color temperatures of the accessory when offset user interface object 652a is in default position 652b (e.g., before electronic device 600 detects right swipe gesture 650o). Thus, the position of offset user interface object 652a and the one or more environmental characteristics (e.g., time of year, location, weather) affect the color temperatures for a light accessory using when the dynamic color temperature setting is selected for the light accessory using electronic device 600.

FIG. 8 is a flow diagram illustrating a method for managing lighting accessories using an electronic device in accordance with some embodiments. Method 800 is performed at a device (e.g., 100, 300, 500) with a display. Some operations in method 800 are, optionally, combined, the orders of some operations are, optionally, changed, and some operations are, optionally, omitted.

In some embodiments, the electronic device (e.g., 600) is a computer system. The computer system is optionally in communication (e.g., wired communication, wireless communication) with a display generation component and with one or more input devices. The display generation component is configured to provide visual output, such as display via a CRT display, display via an LED display, or display via image projection. In some embodiments, the display generation component is integrated with the computer system. In some embodiments, the display generation component is separate from the computer system. The one or more input devices are configured to receive input, such as a touch-sensitive surface receiving user input. In some embodiments, the one or more input devices are integrated with the computer system. In some embodiments, the one or more input devices are separate from the computer system. Thus, the computer system can transmit, via a wired or wireless connection, data (e.g., image data or video data) to an integrated or external display generation component to visually produce the content (e.g., using a display device) and can receive, a wired or wireless connection, input from the one or more input devices.

As described below, method 800 provides an intuitive way for managing light accessories. The method reduces the cognitive burden on a user for managing light accessories, thereby creating a more efficient human-machine interface. For battery-operated computing devices, enabling a user to manage light accessories faster and more efficiently conserves power and increases the time between battery charges.

An electronic device (e.g., 600) includes a display (e.g., a touch screen display having a touch-sensitive surface). The electronic device (e.g., 600) displays (802), on the display, a user interface (e.g., 620) including a plurality of affordances (e.g., 620d, 620e, 620f, 620g, 620h, 620i, 620j) to control a light (e.g., a light that can be remotely controlled by the electronic device to independently adjust a brightness of the light and a color of the light, such as the color temperature of the light). The plurality of affordances (e.g., 620d, 620e, 620f, 620g, 620h, 620i, 620j) include (e.g., concurrent display of) a first affordance (804) (e.g., 620e) configured to, in response to detecting user input (e.g., 650e) corresponding to the first affordance (e.g., 620e), cause adjustment of a color temperature setting of the light to a variable color temperature that is based on one or more environmental characteristics and a second affordance (806) (e.g., 620f, 620g, 620h, 620i, 620j), different from the first affordance (e.g., 620e) (e.g., displayed adjacent to the first affordance), configured to, in response to detecting user input corresponding to the second affordance (e.g., 620f, 620g, 620h, 620i, 620j), cause adjustment of the color temperature setting of the light to a particular (e.g., static) color temperature. The one or more environmental characteristics include a current time of day. In some embodiments, the first affordance is configured to dynamically adjust the color temperature setting to cause the light to change color without user input. In some embodiments, the second affordance is configured to statically adjust the color temperature setting to cause the light to be set to a particular color temperature that is not based on the time of day (e.g., a color temperature that is predefined or static). While displaying the user interface, the electronic device (e.g., 600) detects (808) first user input (e.g., a tap gesture on a touch-sensitive surface of the electronic device). In response to detecting the first user input and in accordance with a determination that the first user input (e.g., 650e) corresponds to the first affordance (e.g., 620e) (e.g., the user input is a tap gesture at a location corresponding to the first affordance), the electronic device (e.g., 600) causes (810) adjustment of the color temperature setting of the light to the variable color temperature that is based on the one or more environmental characteristics (e.g., based on all of the environmental characteristics). In some examples, the variable color temperature changes over time based on the one or more environmental characteristics as the one or more environmental characteristics change over time. In some examples, in response to detecting the user input and in accordance with the determination that the user input corresponds to the first affordance, the electronic device sends a plurality of instructions over a time period (e.g., 5 instructions over 5 hours, 1 instruction per hour, 50 instructions over 5 hours, 10 instructions per hour) to cause adjustment of the color temperature of the light to a particular color temperature over the time period based on the one or more environmental characteristics at the time that each instruction is sent (e.g., an initial color temperature at one point in time during the time period, a different color temperature at a different point in time during the time period). In some examples, in response to detecting the user input and in accordance with the determination that the user input corresponds to the first affordance, the electronic device sends a single instruction to cause adjustment of the color temperature of the light to a particular color temperature over time based on the one or more environmental characteristics as the one or more environmental characteristics change (e.g., an initial color temperature at one point in time during the time period, a different color temperature at a different point in time during the time period).

Adjusting the color temperature of a light over time using a variable color temperature based on environmental conditions over that same time, without further user input, allows the user to control an external light with limited inputs. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, in response to detecting the first user input and in accordance with a determination that the first user input corresponds to the second affordance (e.g., 620f, 620g, 620h, 620i, 620j) (e.g., the user input is a tap gesture at a location corresponding to the second affordance), the electronic device (e.g., 600) causes adjustment of the color temperature setting of the light to the particular color temperature, where the particular color temperature is not based on the one or more environmental characteristics (e.g., a fixed color temperature, a static color temperature, and/or a color temperature that does not change over a time period).

In some embodiments, the plurality of affordances includes a third affordance (e.g., 620d) (e.g., a slider affordance) configured to, in response to detecting user input (e.g., 650d, 650f) corresponding to the third affordance, adjust a brightness setting of the light (e.g., an offset of a variable brightness (e.g., intensity) of the light that is based on the one or more environmental characteristics). In some embodiments, adjusting the brightness setting of the light also concurrently adjusts the color temperature of the light. In some embodiments, adjusting the brightness of the light maintains the color temperature of the light. In some embodiments, the brightness setting of the light is adjusted (e.g., automatically) based on the one or more environmental characteristics. As such, the third affordance may offset a brightness setting of the light that is based on the one or more environmental characteristics. In some embodiments, in response to detecting the first user input (e.g., 650d, 650f) and in accordance with a determination that the first user input (e.g., 650d, 650f) corresponds to the third affordance (e.g., 620d) (e.g., sliding a slider of a slider affordance), the electronic device (e.g., 600) causes adjustment of the brightness setting of the light (e.g., an intensity of the light at a respective color temperature at a given time during a time period is adjusted based on a position of the slider of the slider affordance after the first user input is received and/or an amount of movement of the slider of the slider affordance caused by the first user input).

In some embodiments, in response to detecting the first user input (e.g., 650d, 650f) and in accordance with a determination that the first user input (e.g., 650d, 650f) corresponds to the third affordance (e.g., 620d), in accordance with a determination that the light is configured to be a variable color temperature that is based on the one or more environmental characteristics, the electronic device (e.g., 600) applies an offset to the adjustment of the color temperature setting of the light by a first amount, the first amount based on the adjustment of the brightness setting of the light. In some embodiments, in response to receiving input at the third affordance, the electronic device transmits instructions to the light specifying an updated brightness and (e.g., separately) an updated color temperature. In some embodiments, adjusting the temperature setting of the light based on the brightness setting of the light includes applying an offset to the color temperature setting of the light. In some embodiments, adjustment of the color temperature of the light, based on changes to the brightness setting of the light, is limited to different color temperature limits for different times of the day. For example, varying the brightness setting of the light at 9 am enables transitioning the light among a first range of color temperatures and varying the brightness setting of the light at 6 pm enables transitioning the light among a second range of color temperatures different from the first range of color temperatures. In some embodiments, in response to detecting the first user input (e.g., 650d, 650f) and in accordance with a determination that the light is configured to be a particular (e.g., static) color temperature, the electronic device (e.g., 600) forgoes applying the offset (e.g., any offset) to the adjustment of the color temperature setting of the light (e.g., when a static color temperature affordance is selected by the user, adjusting the brightness of the light does not change the color temperature of the light).

In some embodiments, the first affordance (e.g., 620e) is configured to, in response to detecting user input corresponding to the first affordance, cause adjustment of a brightness setting (e.g., an intensity of the light at a respective color temperature at a given time during a time period) of the light to a variable brightness that is based on the one or more environmental characteristics (e.g., the first affordance is configured to dynamically adjust the brightness setting to cause the intensity of the light to change without user input). In some embodiments, in response to detecting the first user input (e.g., 650e) and in accordance with the determination that the first user input corresponds to the first affordance (e.g., 620e) (e.g., the user input is a tap gesture at a location corresponding to the first affordance), the electronic device (e.g., 600) causes adjustment of the brightness setting of the light to the variable brightness based on the one or more environmental characteristics (e.g., based on all of the environmental characteristics). In some examples, the variable brightness changes over time based on the one or more environmental characteristics as the one or more environmental characteristics change over time. In some examples, in response to detecting the user input and in accordance with the determination that the user input corresponds to the first affordance, the electronic device sends a plurality of instructions over a time period (e.g., 5 instructions over 5 hours, 1 instruction per hour, 50 instructions over 5 hours, 10 instructions per hour) to cause adjustment of the brightness setting of the light to a particular brightness over the time period based on the one or more environmental characteristics at the time that each instruction is sent (e.g., a brightness setting at one point in time during the time period, a different brightness setting at a different point in time during the time period). In some examples, in response to detecting the user input and in accordance with the determination that the user input corresponds to the first affordance, the electronic device sends a single instruction to cause adjustment of the brightness setting of the light to various brightness levels over time based on the one or more environmental characteristics as the one or more environmental characteristics change (e.g., a brightness setting at one point in time during the time period, a different brightness setting at a different point in time during the time period).

Adjusting the brightness of a light over time based on environmental conditions over that same time, without further user input, allows the user to control an external light with limited inputs. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the variable color temperature is based on a current brightness setting of the light (e.g., an intensity of the light at a given time during a time period). In some examples, the color temperature of the light is adjusted based on a current brightness setting of the light that is either user defined or determined based on the one or more environmental characteristics. For example, the color temperature of the light becomes warmer at lower brightness settings and cooler at higher brightness settings to resemble natural light patterns.

In some embodiments, causing adjustment of the color temperature setting of the light to the variable color temperature includes the electronic device (e.g., 600) applying an offset to the adjustment of the color temperature setting of the light. The offset to the color temperature setting of the light causes the color temperature setting of the light to vary within a range of color temperature settings (e.g., a range of color temperature settings includes a plurality of color temperature settings that the light may be adjusted toward). The range of color temperature settings is based on the one or more environmental characteristics including time of day, time of year, and latitude of geographical location (e.g., the range of color temperature settings may be offset toward warmer or cooler colors based on a time of day, time of year, location, weather, etc. of the computer system, or the light). In some examples, the range of color temperature setting causes the color temperature of the light to be adjusted at different times of the day based on the time of year (e.g., winter versus summer), location (e.g., sun rises and sets at different times based on location of the light), and/or weather patterns (e.g., cloudy versus sunny weather). The color temperature of the light is adjusted to a warmer color temperature at an earlier time of the day during the winter when there is less daylight and the color temperature of the light is adjusted to a warmer color temperature at a later time of the day during the summer when there is an increased amount of daylight. In some examples, the range of color temperature settings may include warmer color temperatures on average during the winter when compared to the range of color temperature settings during the summer. In some examples, the range of color temperature settings is based on a brightness setting of the light (e.g., the range of color temperature settings may be adjusted toward warmer or cooler colors based on the brightness setting of the light).

Adjusting the color temperature of a light over time based on environmental conditions over that same time, without further user input, allows the user to control an external light with limited inputs. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the one or more environmental characteristics include a time of year (e.g., month and day of the year). In some examples, the time of year causes the variable color temperature to dynamically adjust the color temperature setting throughout a single day differently each day, each week, each month, each season, etc. For example, the dynamic adjustment of the color temperature is different during the summer than during the winter due to the increased daylight that is experienced during the summer.

Adjusting the color temperature of a light over time based on a time of year (e.g., day of year, month of year), without further user input, allows the user to control an external light with limited inputs. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the one or more environmental characteristics include a location (e.g., of the electronic device, of the light, a latitude and/or longitude of the location of the electronic device or light). In some examples, the dynamic adjustment of the color temperature is different in different locations around the world (e.g., the sun rises and sets at different times depending on a specific location around the globe). In some examples, the dynamic adjustment of the variable color temperature is further based on weather conditions at the location (e.g., clouds/storms may cause the color temperature to adjust to a warmer color temperature than sunny/clear weather). In some examples, the dynamic adjustment of the variable color temperature is based on a current time of day, a time of year, weather conditions, and a location of the light.

Adjusting the color temperature of a light over time based on a location, without further user input, allows the user to control an external light with limited inputs. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the electronic device (e.g., 600) receives third user input (e.g., 650o, 650p) (e.g., the third user input may correspond to selection of a menu option (e.g., “Automatic Lighting”) that enables a user to adjust the settings associated with the ability to dynamically adjust the color temperature setting of the light based on the one or more environmental characteristics). In response to receiving the third user input (e.g., 650o, 650p) (e.g., a tap on an affordance representing the menu option displayed on the user interface), the electronic device (e.g., 600) applies an offset to the variable color temperature (e.g., by offsetting the color temperature by an offset amount) based on (e.g., a magnitude of) the third user input (e.g., the third user input corresponds to a slider affordance that enables a user to slide a slider to scale the variable color temperature that is based on the current time of day to warmer colors, cooler colors, or a default setting that is between a maximum warm setting and a maximum cool setting). In some examples, applying the offset to the variable color temperature causes each color temperature that would be set throughout the day to become warmer or cooler based on where the user slides the slider affordance. In some examples, the computer system determines a scaling factor based on the third user input and the offset is based on the scaling factor (e.g., a distance of the third user input, a duration of the third user input, the third user input includes selection of a numeric value). In some embodiments, the adjustment based on the third user input applies to the variable color temperature and does not apply to the static colors (e.g., the variable color temperatures are offset, but the static colors remain unchanged).

In some embodiments, causing adjustment of the color temperature setting of the light to the variable color temperature that is based on the one or more environmental characteristics includes the electronic device (e.g., 600) adjusting the color temperature setting of the light asymmetrically throughout the day (e.g., 700, 706) (e.g., adjustment of the variable color temperature follows a curve (e.g., 700, 706) based on natural light patterns determined using the one or more environmental factors). Natural light tends to increase in brightness and temperature rapidly when the sun first rises, levels off during the late morning and into the afternoon, gradually decreases into the evening, and rapidly decreases at night. In some examples, the color temperature setting of the light would be adjusted dynamically according to the pattern of natural light in order to resemble the light (or lack thereof) that is present outdoors. In some examples, the curve used to perform the dynamic adjustment of the color temperature setting is based on time of year, weather, and/or location to more closely resemble the natural light occurring outdoors in the area in which the light is located.

In some embodiments, the electronic device (e.g., 600) displays a second user interface including a plurality of default color temperature affordances (e.g., options that enable a user to select a default color temperature of the light, such as a particular color temperature or the variable color temperature, when the light is turned on) configured to, in response to detecting user input corresponding to a respective default color temperature affordance of the plurality of default color temperature affordances, cause adjustment of the color temperature setting of the light to a default color temperature setting corresponding to the default color temperature affordance based on a transition of the light from an inactive state (e.g., a power off state; a state in which the light is not providing any light but the light is receiving power, a state in which the light is not receiving power) to an active state (e.g., a power on state; a state in which the light is instructed to provide light, a state in which the light is receiving power) (In some examples, selection of the default color temperature affordance causes the light to turn on with the default color temperature each time the light is switched from off to on or each time the light transitions from not receiving power to receiving power.).

In some embodiments, the plurality of default color temperature affordances include one or more of a first default color temperature affordance configured to, in response to detecting user input corresponding to the first default color temperature affordance, cause adjustment of the color temperature setting of the light to a last used color temperature setting based on the transition of the light from the inactive state to the active state (e.g., upon turning the light from off to on, the color temperature setting of the light is adjusted to a color temperature of the light when the light was most recently turned off; upon the light transitioning from not receiving power to receiving power, the color temperature setting of the light is adjusted to a color temperature of the light when the light stopped receiving power), a second default color temperature affordance configured to, in response to detecting user input corresponding to the second default color temperature affordance, cause adjustment of the color temperature setting of the light to a first color temperature setting (e.g., the first color temperature setting is a white color temperature that includes an offset that is set or determined by the user (e.g., the slider that enables the user to select a desired color temperature offset for the automatic lighting feature) and/or based on the one or more environmental characteristics) based on the transition of the light from the inactive state to the active state (e.g., upon turning the light from off to on or upon the light transitioning from not receiving power to receiving power, the color temperature setting of the light is adjusted to the first color temperature), a third default color temperature affordance configured to, in response to detecting user input corresponding to the third default color temperature affordance, cause adjustment of the color temperature setting of the light to the variable color temperature based on the transition of the light from the inactive state to the active state (e.g., upon turning the light from off to on or upon the light transitioning from not receiving power to receiving power, the color temperature setting of the light is adjusted to the variable color temperature setting that is based on the time of day and/or the one or more environmental characteristics (e.g., time of year, weather, location)), and a fourth default color temperature affordance configured to, in response to detecting user input corresponding to the fourth default color temperature affordance, cause adjustment of the color temperature setting of the light to a second color temperature setting (e.g., a color temperature set by the user that is not based on the offset to the color temperature set by the user and/or based on the one or more environmental characteristics) based on the transition of the light from the inactive state to the active state (e.g., upon turning the light from off to on or upon the light transitioning from not receiving power to receiving power, the color temperature setting of the light is adjusted to a particular color temperature that was previously set by the user). In some examples, selecting the third default color temperature affordance causes the color temperature setting of the light to be different based on the time at which the user turns the light from off to on. In some examples, selection of the fourth default color temperature affordance displays another affordance that enables the user to select the static/particular color temperature of the light.

Providing various options for a default color of an external light allows the user to configure the external light to have certain visual characteristics each time the light is turned on, without requiring additional inputs to re-configure the light each time it is turned on, thereby reducing the number of inputs required to achieve the visual characteristics. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the one or more environmental characteristics include a color (e.g., a predominant color, a user defined color, or a blend of colors) of a physical environment in which the light (or electronic device) is located (e.g. at least one color of a room (e.g., a paint color of walls in the room and/or a blend of colors of objects in the room) in which the light is located, at least one color associated with a location of a building in which the light is located (e.g., cooler colors for a metropolitan location versus warmer colors for a rural location), and/or at least one color of an object nearest to the light in a room in which the light is located). In some examples, the color is detected via a camera of the electronic device. In some embodiments, the color of the physical environment is set by receiving user input (e.g., entered into a settings menu associated with control of the light). In some embodiments, the color of the physical environment is detected via a camera of an external device (e.g., a smart home device that includes a camera and is connected (e.g., via wire, wirelessly) to the electronic device that includes the affordances for controlling the light). In some examples, the color of the physical environment is determined based on a location (e.g., of the device, of the light). In some examples, the location is a geographic or other location (e.g., metropolitan versus rural location).

In some embodiments, prior to displaying the user interface that includes the plurality of affordances to control the light (and prior to detecting the first input), the electronic device receives a request to display an application corresponding to the user interface (e.g., detect selection of an affordance corresponding to the application and, in response, displaying the application (e.g., for a first time to set up the light)). In response to the request to display the application and in accordance with a determination that a connected light (e.g., the light) is capable of adjustment of the color temperature setting to the variable color temperature based on the one or more environmental characteristics (e.g., the light includes a bulb or other device that is capable of outputting multiple different colors or color temperatures and the light is capable of communicating/connecting to the electronic device via Bluetooth, Wi-Fi, or another suitable communication technique, the light is capable of directly connecting to the Internet via Wi-Fi, or the light is capable of communicating/connecting to an external device (e.g., a smart home device that is connected to the Internet) via Bluetooth, Wi-Fi, or another suitable communication technique), the electronic device displays an indication (e.g., a visual indication) that the connected light is capable of adjustment of the color temperature setting to the variable color temperature based on the one or more environmental characteristics. In response to the request to display the application and in accordance with a determination that no connected light is capable of adjustment of the color temperature setting to the variable color temperature based on the one or more environmental characteristics (e.g., the light does not include a bulb or other device that is capable of outputting multiple different colors or color temperatures and/or the light is not capable of communicating/connecting to the electronic device via Bluetooth, Wi-Fi, or another suitable communication technique, the light is not capable of directly connecting to the Internet via Wi-Fi, and the light is not capable of communicating/connecting to an external device (e.g., a smart home device that is connected to the Internet) via Bluetooth, Wi-Fi, or another suitable communication technique), the electronic device forgoes display of the indication.

In some embodiments, while displaying the user interface, the electronic device detects a second user input (e.g., the second user input may correspond to selection of a menu option (e.g., “Scenes”) that enables a user to create a schedule that automatically adjusts the color temperature setting and/or the brightness setting of the light at times selected by the user (e.g., sunrise/sunset or times related to the user's sleep schedule)). In response to detecting the second user input (e.g., a tap on an affordance representing the menu option displayed on the user interface), the electronic device displays a second user interface (e.g., a user interface associated with the ability to enable the user to create schedules that automatically adjust the color temperature setting and/or the brightness setting of the light (e.g., “Scenes”)) including a third affordance configured to, in response to detecting user input corresponding to the third affordance, cause adjustment to a brightness setting of the light (and/or turning/fading the light on or off) at a user-specified time of day (e.g., the third affordance may enable a user to select a time that the brightness setting of the light fades in or out (e.g., the time may be user defined, based on time of year, and/or based on location of the light), a brightness setting (e.g., percentage) that the light will fade toward, a duration at which the fading will occur (e.g., duration of adjustment from a current brightness setting to a predefined or selected brightness setting)). While displaying the second user interface, the electronic device detects third user input (e.g., a tap on the third affordance). In response to detecting the third user input and in accordance with a determination that the user input corresponds to the third affordance, the electronic device causes adjustment of the brightness setting of the light at the user-specified time of day, where the brightness setting is based on the one or more environmental characteristics (e.g., the brightness setting of the light automatically adjusts at the predefined time of day that may be selected by the user). In some examples, the user may specify that the time of day vary based on the time of year and/or location of the light (e.g., when sunrise or sunset occurs). In some examples, the predefined time of day may be static (e.g., the brightness setting of the light is adjusted automatically at the same time each day based on when the user expects to wake up or go to sleep).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve light settings. The present disclosure contemplates that in some instances, this gathered data may include personal information data. Such personal information data can include location-based data or home addresses.

The present disclosure recognizes that the use of such personal information data, in the present technology, can be used to the benefit of users. For example, the personal information data can be used to change light settings. Accordingly, use of such personal information data enables users to better user lights. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers, controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. An electronic device, comprising:
a display device;
one or more input devices;
one or more processors; and
memory storing one or more programs configured to be executed by the one or more processors, the one or more programs including instructions for:
after associating a light accessory with a home automation system, detecting, via the one or more input devices, a request to display a user interface corresponding to the home automation system; and
in response to detecting the request to display the user interface corresponding to the home automation system, displaying the user interface corresponding to the home automation system, including:
in accordance with a determination that the user interface corresponding to the home automation system is displayed for a first time since associating the light accessory with the home automation system, displaying, via the display device, notification corresponding to an automated lighting feature, wherein the notification includes:
an activation user interface object that, when selected via user input, initiates a process to activate an automated lighting feature of the lighting accessory; and
a cancel user interface object that, when selected via user input, forgoes initiating the process to activate the automated lighting feature of the lighting accessory.

2. The electronic device of claim 1, wherein displaying the user interface corresponding to the home automation system includes:
in accordance with a determination that the user interface corresponding to the home automation is not displayed for the first time since associating the light accessory with the home automation system, forgoing display of the notification corresponding to the automated lighting feature.

3. The electronic device of claim 1, wherein the one or more programs further include instructions for:
while displaying, via the display device, the notification corresponding to an automated lighting feature, detecting via the one or more input devices, user input corresponding to selection of the activation user interface object; and
in response to detecting the user input corresponding to selection of the activation user interface object, displaying, via the display device, a settings user interface, wherein the settings user interface includes one or more control user interface objects corresponding to respective settings of the automated lighting feature of the light accessory.

4. The electronic device of claim 1, wherein the one or more programs further include instructions for:
while displaying, via the display device, the notification corresponding to an automated lighting feature, detecting via the one or more input devices, user input corresponding to selection of the activation user interface object; and
in response to detecting the user input corresponding to selection of the activation user interface object:
at a first time of day:
causing adjustment of a color temperature setting of the light accessory to a first color temperature that is based on one or more environmental characteristics; and
at a second time of day that is after the first time of day:
causing adjustment of the color temperature setting of the light accessory to a second color temperature that is different from the first color temperature, wherein the second color temperature is based on the one or more environmental characteristics.

5. The electronic device of claim 4, wherein the one or more programs further include instructions for:
in response to detecting the user input corresponding to selection of the activation user interface object:
at the first time of day:
causing adjustment of a brightness setting of the light accessory to a first brightness that is based on the one or more environmental characteristics; and
at the second time of day that is after the first time of day:
causing adjustment of the brightness setting of the light accessory to a second brightness that is different from the first brightness, wherein the second brightness is based on the one or more environmental characteristics.

6. The electronic device of claim 4, wherein the one or more environmental characteristics are selected from the group consisting of: time of day, time of year, and location.

7. The electronic device of claim 1, wherein the one or more programs further include instructions for:
while displaying, via the display device, the notification corresponding to an automated lighting feature, detecting via the one or more input devices, user input corresponding to selection of the activation user interface object; and
in response to detecting the user input corresponding to selection of the activation user interface object, adjusting a color temperature setting of the light accessory asymmetrically throughout a day.

8. The electronic device of claim 1, wherein displaying the user interface corresponding to the home automation system includes displaying, via the display generation component, a light user interface object corresponding to the light accessory.

9. The electronic device of claim 8, wherein the one or more programs further include instructions for:
detecting, via the one or more input devices, user input corresponding to selection of the light user interface object corresponding to the light accessory; and
in response to detecting the user input corresponding to selection of the light user interface object corresponding to the light accessory, displaying, via the display device, a lighting user interface.

10. The electronic device of claim 9, wherein displaying the lighting user interface includes concurrently displaying, via the display device:
a first affordance configured to, in response to detecting user input corresponding to the first affordance, cause adjustment of a color temperature setting of the light accessory to a variable color temperature that is based on one or more environmental characteristics; and
a second affordance, different from the first affordance, configured to, in response to detecting user input corresponding to the second affordance, cause adjustment of the color temperature setting of the light to a first particular color temperature.

11. The electronic device of claim 10, wherein displaying the lighting user interface includes concurrently displaying, via the display device and with the first affordance and the second affordance:
a slider user interface object that is different from the first affordance and the second affordance, wherein the slider user interface object is configured to, in response to detecting user input corresponding to the slider user interface object, cause an adjustment of a brightness setting of the light accessory.

12. The electronic device of claim 8, wherein displaying the user interface corresponding to the home automation system includes concurrently displaying, via the display generation component, the light user interface object corresponding to the light accessory and an accessory user interface object corresponding to an accessory that is different from the light accessory, wherein the accessory is associated with the home automation system.

13. A non-transitory computer-readable storage medium storing one or more programs configured to be executed by one or more processors of an electronic device with a display device and one or more input devices, the one or more programs including instructions for:
after associating a light accessory with a home automation system, detecting, via the one or more input devices, a request to display a user interface corresponding to the home automation system; and
in response to detecting the request to display the user interface corresponding to the home automation system, displaying the user interface corresponding to the home automation system, including:
in accordance with a determination that the user interface corresponding to the home automation system is displayed for a first time since associating the light accessory with the home automation system, displaying, via the display device, notification corresponding to an automated lighting feature, wherein the notification includes:
an activation user interface object that, when selected via user input, initiates a process to activate an automated lighting feature of the lighting accessory; and
a cancel user interface object that, when selected via user input, forgoes initiating the process to activate the automated lighting feature of the lighting accessory.

14. A method comprising:
at an electronic device with a display device and one or more input devices:
after associating a light accessory with a home automation system, detecting, via the one or more input devices, a request to display a user interface corresponding to the home automation system; and
in response to detecting the request to display the user interface corresponding to the home automation system, displaying the user interface corresponding to the home automation system, including:
in accordance with a determination that the user interface corresponding to the home automation system is displayed for a first time since associating the light accessory with the home automation system, displaying, via the display device, notification corresponding to an automated lighting feature, wherein the notification includes:
an activation user interface object that, when selected via user input, initiates a process to activate an automated lighting feature of the lighting accessory; and
a cancel user interface object that, when selected via user input, forgoes initiating the process to activate the automated lighting feature of the lighting accessory.
